(19) United States
(12) Patent Application Publication
(10) Pub. No.: US 2006/0214842 A1
(43) Pub. Date: Sep. 28, 2006

(54) Mixer, High-Frequency transmitting/receiving apparatus having the same, radarapparatus having the high-frequency transmitting/receiving apparatus, and vehicle equipped with radar apparatus

(75) Inventors: Takeshi Takenoshita, Soraku-gun (JP); Kazuki Hayata, Soraku-gun (JP); Yuji Kishida, Soraku-gun (JP)

Correspondence Address: HOGAN & HARTSON L.L.P., 500 S. GRAND AVENUE, SUITE 1900, LOS ANGELES, CA, 90071-2611, US

(73) Assignee: KYOCERA CORPORATION

(21) Appl. No.: 11/169,334

(22) Filed: Jun. 28, 2005

(30) Foreign Application Priority Data
Jun. 29, 2004 (JP) P2004-191733

(51) Int. Cl. G01S 13/08; G01S 13/93

(52) U.S. Cl. 342/175; 342/118; 342/70; 342/132; 342/134

(57) ABSTRACT

A mixer capable of keeping mixing characteristics tuned satisfactorily is provided. A coupler includes two input ends, and one or two output ends. At the output end is disposed a Schottky-barrier diode acting as a high-frequency detection element. Connected to the Schottky-barrier diode is a bias supply circuit having a trimmable chip resistor acting as a pre-set variable resistor, for controlling a bias current which passes through the Schottky-barrier diode. By adjusting the resistance of the trimmable chip resistor, it is possible to control a bias current passing through the Schottky-barrier diode, and thereby keep mixing characteristics tuned satisfactorily.

### BACKGROUND OF THE INVENTION

1. Field of the Invention

The present invention relates to a mixer for use in a millimeter-wave integrated circuit, a millimeter-wave radar module, or the like, and more particularly to a mixer in which a bias supply circuit of a high-frequency detection element as a component of the mixer is provided with a pre-set variable resistor thereby to keep characteristics such as mixing characteristics and transmission characteristics of the mixer tuned satisfactorily, and to a high-frequency transmitting/receiving apparatus having the mixer.

The present invention also relates to a radar apparatus having the high-frequency transmitting/receiving apparatus, and a vehicle equipped with the radar apparatus.

2. Description of the Related Art

Some examples of mixers of conventional design have hitherto been known, such as those which have been disclosed in Japanese Unexamined Patent Publications JP-A 10-242766 (1998), JP-A2001-203537, JP-A2002-158540, and JP-A 2002-290113. Among them, disclosed in JP-A 10-242766 is a mixer that employs NonRadiative Dielectric Waveguide (hereafter also referred to simply as “an NRD guide”). In the mixer, at the end of a dielectric strip line are disposed a Schottky-barrier diode acting as a high-frequency detection element and a substrate for supplying a bias to the Schottky-barrier diode. Moreover, a cavity resonator is arranged by way of a direction changer for changing the direction of a magnetic line of force by 90°. Inserted into the cavity resonator is a movable part for varying a resonant frequency. By moving the movable part, the resonant frequency of the cavity resonator is caused to vary, whereby a change can be achieved in an impedance when the Schottky-barrier diode is viewed as from the dielectric strip line.

Moreover, there have been proposed high-frequency transmitting/receiving apparatuses designed to operate in combination with such a mixer, which are expected to find applications in a millimeter-wave radar module, a millimeter-wave wireless radio communications apparatus, or the like. For example, such a high-frequency transmitting/receiving apparatus is disclosed in Japanese Unexamined Patent Publication JP-A 2000-258525. The high-frequency transmitting/receiving apparatus disclosed in JP-A 2000-258525 is of the type that adopts a pulse modulation scheme.

FIG. 18 is a schematic block circuit diagram showing the conventional high-frequency transmitting/receiving apparatus that adopts the pulse modulation scheme. For example, the high-frequency transmitting/receiving apparatus is composed of: a high-frequency oscillator 61 for generating a high-frequency signal; a branching device 62 connected relatively to the output end of the high-frequency oscillator 61, for branching the high-frequency signal so that the branched high-frequency signal components may be outputted to one output end 62b and the other output end 62c thereof, respectively; a modulator 63 connected relatively to the one output end 62b of the branching device 62, for modulating part of the high-frequency signal so as to put it out as a high-frequency signal intended for transmission; a circulator 64 having a first terminal 64a, a second terminal 64b, and a third terminal 64c, of which the first terminal 64a is connected with the output end 63a of the modulator 63, wherein a high-frequency signal inputted from the first terminal 64a is outputted to the second terminal 64b, and a high-frequency signal inputted from the second terminal 64b is outputted to the third terminal 64c; a transmitting/receiving antenna 65 connected to the second terminal 64b of the circulator 64; and a mixer 66 connected between the other output end 62c of the branching device 62 and the third terminal 64c of the circulator 64, for mixing the high-frequency signal outputted to the other output end 62c of the branching device 62 as a local signal L0 and a high-frequency signal received by the transmitting/receiving antenna 65 so as to generate an intermediate-frequency signal.

It has been known that, in such a conventional high-frequency transmitting/receiving apparatus, a nonradiative dielectric line is suitable for use as a high-frequency transmission line for providing connection among the high-frequency circuit elements and transmitting high-frequency signals.

Conventionally, a metal waveguide has commonly been used as means for transmitting micro or millimeter waves. However, in keeping up with the recent demand for a down-sized high-frequency module, development has been under way to come up with a high-frequency module that employs a dielectric strip line as a waveguide for transmitting high-frequency signals. Against this backdrop, the nonradiative dielectric line has attracted much attention as a new high-frequency transmission line because of its ability to transmit high-frequency signals with low loss.

FIG. 17 is a partial cutaway perspective view showing the basic structure of the nonradiative dielectric line. The nonradiative dielectric line is constructed by interposing a dielectric strip line 53 having a quadrilateral, for example, rectangular cross-sectional profile between a pair of parallel plate conductors 51 and 52 parallely arranged at a predetermined interval a. Here, it is preferable that the relationship between the interval a and the wavelength λ of a high-frequency signal is given by the expression: a≦λ/2. By setting the interval a in this way, it is possible to allow high-frequency signals to propagate efficiently through the dielectric strip line 53 while eliminating entrance of noise into the dielectric strip line 53 from the outside and radiation of the high-frequency signals to the outside. Note that the wavelength λ of a high-frequency signal represents a wavelength in the air (free space) at a usable frequency.

Moreover, examples of a conventional radar apparatus having the high-frequency transmitting/receiving apparatus and a vehicle equipped with the radar apparatus are disclosed in Japanese Unexamined Patent Publication JP-A 2003-35768, for example.

However, conventional constructions have the following disadvantages. In such a mixer as disclosed in JP-A 10-242766, an adjustment mechanism (corresponding to the cavity resonator and the movable part, as exemplified) for adjusting mixing characteristics and the transmission characteristics of the mixer is so formed as to extend from the high-frequency detection element arranged at the end of the high-frequency transmission line. By adjusting its structural dimension, the electrical length of the adjustment mechanism through which high-frequency signals are transmitted is caused to vary, so that a change may be achieved in the impedance at the end of the adjustment mechanism. In this case, however, there is a risk of the electrical length being varied in the presence of only slight play in the structure. This gives rise to a problem of poor controllability. In an attempt to overcome the problem, removing the play nearly perfectly leads to an impractical scale-up of the adjustment mechanism as a whole.

Furthermore, occurrence of oscillation or thermal expansion and contraction causes deviation in the electrical length of the adjustment mechanism such as the cavity resonator and the movable part. Thus, although the electrical length is adjusted optimally in advance, it may be deviated easily. This gives rise to a problem of poor stability.

In addition, in the conventional high-frequency transmitting/receiving apparatus having such a mixer, because of tuning inaccuracy or instability in the mixer, it is impossible to ensure a uniform reception sensitivity. This gives rise to a problem of difficulty in attaining excellent characteristics with stability.

On the other hand, in the high-frequency transmitting/receiving apparatus disclosed in JP-A 2000-258525, as shown in the schematic block circuit diagram depicted in FIG. 18, part of the local signal L0 reflected from the mixer 66 leaks from the third terminal 64c to the first terminal 64a of the circulator 64. The resultant leakage high-frequency signal is totally reflected from the modulator 63 kept in an OFF state, and is then inconveniently transmitted from the transmitting/receiving antenna 65 as an unwanted high-frequency signal, in consequence whereof there results an undesirable decrease in ON/OFF ratio, which is the intensity ratio between a high-frequency signal intended for transmission transmitted from the transmitting/receiving antenna 65 when the modulator 63 is kept in an ON state and a high-frequency signal intended for transmission transmitted from the transmitting/receiving antenna 65 when the modulator 63 is kept in an OFF state. This leads to degradation of the transmission/reception performance. That is, with transmission of such an unwanted high-frequency signal, the high-frequency signal finds its way into a target high-frequency signal RF to be received. This gives rise to a problem that part of the high-frequency signal RF is unlikely to be received properly.

Moreover, in the radar apparatus employing such a high-frequency transmitting/receiving apparatus, a low-intensity high-frequency signal reflected from a far-off object to be detected is buried in a high-frequency signal transmitted when the modulator 63 is kept in an OFF state, namely, noise. This leads to narrowness in detectable range and susceptibility to erroneous detection, which give rise to a problem of a delay in detecting an object to be detected.

Further, in the vehicle or small boat equipped with such a radar apparatus, a to-be-detected object is detected by the radar apparatus. In response to the detected information, the vehicle or small boat takes proper action such as collision avoidance and braking. However, because of the delay of target detection, an abrupt action is caused in the vehicle or small boat after the detection operation.

### SUMMARY OF THE INVENTION

The invention has been devised in view of the above-described problems of which improvement is desired with the conventional art, and accordingly one object of the invention is to provide a mixer in which a bias supply circuit of a high-frequency detection element for constituting the mixer is provided with a pre-set variable resistor thereby to keep characteristics such as mixing characteristics and transmission characteristics of the mixer tuned satisfactorily, and also provide a high-frequency transmitting/receiving apparatus having the mixer that is remarkable for constructional simplicity and performance, and is capable of offering excellent reception performance, with high transmission power ON/OFF ratio, by preventing part of a high-frequency signal intended for transmission from being transmitted as an unwanted signal when a modulator is kept in an OFF state.

Another object of the invention is to provide a radar apparatus having the high-performance high-frequency transmitting/receiving apparatus, and a vehicle equipped with the radar apparatus.

The invention provides a mixer comprising:

a coupler having two input ends and one or two output ends;

a high-frequency detection element disposed at the output end of the coupler; and

a bias supply circuit connected to the high-frequency detection element, for supplying a bias current to the high-frequency detection element; wherein the high-frequency detection element is provided with a pre-set variable resistor for controlling the bias current which passes through the high-frequency detection element.

According to the invention, in the mixer, the coupler includes two input ends and one or two output ends. At the output end of the coupler is disposed the high-frequency detection element. Connected to the high-frequency detection element is the bias supply circuit having the pre-set variable resistor for controlling a bias current which passes through the high-frequency detection element. In this construction, by virtue of the pre-set variable resistor, in accordance with the property of the high-frequency detection element, such as characteristics of noise generated by a resistance component of the high-frequency detection element, and the manner of mounting the high-frequency detection element, a bias current can be set at an appropriate value at the time of adjusting characteristics such as mixing characteristics and the transmission characteristics of the mixer, and, at all other times, the bias current can be maintained at the preset value with stability in spite of the presence of a slight mechanical play, as compared with a case of exercising electrical length control. Thus, in contrast to the case of exercising electrical length control, even if a mechanical play exists, it is possible to stabilize the working condition after the setting. As a result, characteristics such as mixing characteristics and the transmission characteristics of the mixer can be tuned with high accuracy and stability.

In the invention, it is preferable that a trimmable chip resistor is employed as the pre-set variable resistor of the mixer.

According to the invention, in the mixer, a trimmable chip resistor is preferably employed as the pre-set variable resistor. In the absence of a movable part, the trimmable chip resistor is able to act to maintain a determined resistance without fail in spite of occurrence of an external force such as vibration. As a result, the aforementioned characteristics can be tuned with higher stability.

The invention provides a high-frequency transmitting/receiving apparatus comprising:

a high-frequency oscillator for generating a high-frequency signal;

a branching device having two output portions, connected to the high-frequency oscillator, for branching the high-frequency signal given by the high-frequency oscillator and outputting the branched high-frequency signal components from one and the other of the two output portions, respectively;

a modulator connected to the one output portion of the branching device, for modulating the branched high-frequency signal component and outputting a high-frequency signal intended for transmission;

a signal separating device having a first terminal, a second terminal, and a third terminal, for receiving at the first terminal the high-frequency signal intended for transmission from the modulator, for outputting from the second terminal the high-frequency signal intended for transmission inputted from the first terminal, and for outputting from the third terminal a high-frequency signal inputted from the second terminal;

a transmitting/receiving antenna connected to the second terminal; and

any one of the mixers mentioned above having, among the two input ends, one input end connected to the other output portion, and the other input end connected to the third terminal, for mixing the branched high-frequency signal component outputted from the other output portion and a high-frequency signal received by the transmitting/receiving antenna and generating an intermediate-frequency signal.

According to the invention, the high-frequency signal oscillated by the high-frequency oscillator is given to the branching device so as to be branched at the branching device, and the branched high-frequency signal components may be outputted from one output portion and the other output portion of the branching device. The high-frequency signal outputted from the one output portion is given to the modulator so as to be given to the first terminal of the signal separating device as a high-frequency signal intended for transmission. The signal separating device outputs the high-frequency signal intended for transmission given to the first terminal from the second terminal. The high-frequency signal intended for transmission is radiated as an electric wave from the transmitting/receiving antenna connected to the second terminal. A high-frequency signal received by the transmitting/receiving antenna is given to the second terminal, and the signal separating device outputs the high-frequency signal given to the second terminal from the third terminal. The signal separating device can separate the high-frequency signal intended for transmission given to the transmitting/receiving antenna and the high-frequency signal received by the transmitting/receiving antenna. The high-frequency signal outputted from the third terminal is given to the other input end of the mixer. At the same time, a local high-frequency signal is given from the other output portion of the branching device to one input end of the mixer, whereby the mixer mixes the high-frequency signal received by the transmitting/receiving antenna and the local high-frequency signal and generates an intermediate-frequency signal. In this high-frequency transmitting/receiving apparatus, one of the mixers of the invention is provided and therefore, by virtue: of the mixer, the mixing characteristics and the transmission characteristics of the mixer can be tuned appropriately in accordance with the property of the high-frequency detection element and the manner of mounting the high-frequency detection element. This makes it possible to realize a high-performance high-frequency transmitting/receiving apparatus that offers excellent reception sensitivity with stability.

In the invention, it is preferable that, in the high-frequency transmitting/receiving apparatus, a transmission coefficient between the two input ends of the mixer is determined in such a way that the following expression holds: Pa₂=Pb₂, under the conditions that a high-frequency signal passing through the modulator placed in an OFF state is defined as Wa₂; a high-frequency signal that has been transmitted from the other output portion of the branching device to the output portion of the modulator by way of the mixer and the signal separating device, and then reflected from the output end of the output portion of the modulator is defined as Wb₂; an intensity of the high-frequency signal Wa₂ is represented by Pa₂; and an intensity of the high-frequency signal Wb₂ is represented by Pb₂.

According to the invention, in the high-frequency transmitting/receiving apparatus, a transmission coefficient between the two input ends of the mixer is determined in such a way that the following expression holds: Pa₂=Pb₂, under the conditions that a high-frequency signal passing through the modulator placed in an OFF state is defined as Wa₂; a high-frequency signal that has been transmitted from the other output portion of the branching device to the output portion of the modulator by way of the mixer and the signal separating device, and then reflected from the output end of the output portion of the modulator is defined as Wb₂; the intensity of the high-frequency signal Wa₂ is represented by Pa₂; and the intensity of the high-frequency signal Wb₂ is represented by Pb₂. In this case, since the transmission coefficient between the input ends of the mixer can be adjusted properly through tuning of the mixer, it is possible to substantially equate the intensity Pa₂ of the high-frequency signal passing through the modulator placed in an OFF state with the intensity Pb₂ of the high-frequency signal reflected from the output end of the modulator after passing through the mixer side and the signal separating device. Therefore, these high-frequency signals interfere with each other effectively thereby to cause attenuation. This makes it possible to realize a high-performance high-frequency transmitting/receiving apparatus in which its transmission/reception capability can be enhanced by preventing part of a high-frequency signal intended for transmission from being transmitted as an unwanted signal when the modulator is kept in an OFF state.

In the invention, it is preferable that a distance (line length) between one output end of the output portion of the branching device and the modulator, or a distance (line length) between the other output end of the output portion of the branching device and the modulator, with the mixer and the signal separating device lying therebetween, is determined in such a way that the following expression holds: δ=(2N+1)·π (N represents an integer), where δ represents the difference in phase between the high-frequency signals Wa₂ and Wb₂ at a center frequency.

According to the invention, in the high-frequency transmitting/receiving apparatus, the distance (line length) between one output end of the output portion of the branching device and the modulator, or the distance (line length) between the other output end of the output portion of the branching device and the modulator, with the mixer and the signal separating device lying therebetween, is determined in such a way that the following expression holds: δ=(2N+1)·π (N represents an integer), where δ represents the difference in phase between the high-frequency signals Wa₂ and Wb₂ at a center frequency. In this case, in the region between the output end of the modulator and the signal separating device, the high-frequency signals Wa₂ and Wb₂ are synthesized in phase opposition and cancel out each other thereby to cause attenuation most effectively. This makes it possible to realize a high-performance high-frequency transmitting/receiving apparatus in which its transmission/reception capability can be enhanced by preventing, in a more effective manner, part of a high-frequency signal intended for transmission from being transmitted as an unwanted signal when the modulator is kept in an OFF state.

The invention provides a high-frequency transmitting/receiving apparatus comprising:

a high-frequency oscillator for generating a high-frequency signal;

a branching device connected to the high-frequency oscillator, for branching the high-frequency signal given by the high-frequency oscillator so that the branched high-frequency signal components may be outputted from one output portion and the other output portion thereof, respectively;

a modulator connected to the one output portion of the branching device, for modulating the high-frequency signal component branched at the one output portion and outputting a high-frequency signal intended for transmission;

an isolator having an input terminal and an output terminal, for outputting the high-frequency signal intended for transmission from the output terminal thereof when the high-frequency signal intended for transmission is given from the modulator to the input terminal thereof;

a transmitting antenna connected to the output terminal;

a receiving antenna; and

one of the mixers mentioned above having, among the two input ends, one input end connected to the other output portion of the branching device and the other input end connected to the receiving antenna, for mixing the branched high-frequency signal component outputted from the other output portion and a high-frequency signal received by the receiving antenna and generating an intermediate-frequency signal.

According to the invention, the high-frequency signal oscillated from the high-frequency oscillator is given to the branching device so as to be branched at the branching device, and the branched high-frequency signal components may be outputted from one output portion and the other output portion of the branching device. The high-frequency signal outputted from the one output portion is given to the modulator so as to be given to the input terminal of the isolator as a high-frequency signal intended for transmission. The isolator passes the high-frequency signal intended for transmission given to the input terminal so as to output the high-frequency signal intended for transmission from the output terminal. The high-frequency signal intended for transmission is radiated as an electric wave from the transmitting antenna connected to the output terminal. A high-frequency signal received by the receiving antenna is given to the other input end of the mixer. At the same time, a local high-frequency signal is given from the other output portion of the branching device to the one input end of the mixer, whereby the mixer mixes the high-frequency signal received by the receiving antenna and the local high-frequency signal and generates an intermediate-frequency signal. In this high-frequency transmitting/receiving apparatus, one of the mixers of the invention is provided and therefore, by virtue of the mixer, mixing characteristics and the transmission characteristics of the mixer can be tuned appropriately in accordance with the property of the high-frequency detection element and the manner of mounting the high-frequency detection element. This makes it possible to realize a high-performance high-frequency transmitting/receiving apparatus that offers excellent reception sensitivity with stability.

The invention provides a high-frequency transmitting/receiving apparatus comprising:

a high-frequency oscillator for generating a high-frequency signal;

a switching device having two output portions, connected to the high-frequency oscillator, for selectively outputting the high-frequency signal given by the high-frequency oscillator from one or both of the output portions thereof;

a signal separating device having a first terminal, a second terminal, and a third terminal, for receiving at the first terminal a high-frequency signal intended for transmission from the one output portion of the switching device, for outputting from the second terminal the high-frequency signal intended for transmission inputted from the first terminal, and for outputting from the third terminal a high-frequency signal inputted from the second terminal;

a transmitting/receiving antenna connected to the second terminal; and

one of the mixers mentioned above having, among the two input ends, one input end connected to the other output portion and the other input end connected to the third terminal, for mixing the high-frequency signal outputted from the other output portion and a high-frequency signal received by the transmitting/receiving antenna so as to generate an intermediate-frequency signal.

According to the invention, the high-frequency signal oscillated from the high-frequency oscillator is given to the switching device. The switching device selectively outputs the high-frequency signal given from the high-frequency oscillator from the one or both of the output portions thereof. The high-frequency signal outputted from the one output portion is given to the first terminal of the signal separating device as a high-frequency signal intended for transmission. The signal separating device outputs the high-frequency signal intended for transmission given to the first terminal from the second terminal. The high-frequency signal intended for transmission is radiated as an electric wave from the transmitting/receiving antenna connected to the second terminal. A high-frequency signal received by the transmitting/receiving antenna is given to the second terminal. The signal separating device outputs the high-frequency signal given to the second terminal from the third terminal. The signal separating device can separate the high-frequency signal intended for transmission given to the transmitting/receiving antenna and the high-frequency signal received by the transmitting/receiving antenna. The high-frequency signal outputted from the third terminal is given to the other input end of the mixer. At the same time, the high-frequency signal outputted from the other output portion of the switching device is given to the one input end of the mixer as a local high-frequency signal. The mixer mixes the high-frequency signal received by the transmitting/receiving antenna and the local high-frequency signal and generates an intermediate-frequency signal. In this high-frequency transmitting/receiving apparatus, one of the mixers of the invention is provided and therefore, by virtue of the mixer, mixing characteristics and the transmission characteristics of the mixer can be tuned appropriately in accordance with the property of the high-frequency detection element and the manner of mounting the high-frequency detection element. This makes it possible to realize a high-performance high-frequency transmitting/receiving apparatus that offers excellent reception sensitivity with stability.

The invention provides a high-frequency transmitting/receiving apparatus comprising:

a high-frequency oscillator for generating a high-frequency signal;

a switching device having two output portions, connected to the high-frequency oscillator, for selectively outputting the high-frequency signal given by the high-frequency oscillator from one or both of the output portions thereof;

a transmitting antenna connected to the one output portion of the switching device;

a receiving antenna; and

one of the mixers mentioned above having, among the two input ends, one input end connected to the other output portion of the switching device and the other input end connected to the receiving antenna, for mixing the high-frequency signal outputted from the other output portion of the switching device and a high-frequency signal received by the receiving antenna so as to generate an intermediate-frequency signal.

According to the invention, the high-frequency signal oscillated from the high-frequency oscillator is given to the switching device. The switching device selectively outputs the high-frequency signal given from the high-frequency oscillator from the one or both of the output portions thereof. The high-frequency signal outputted from the one output portion is given to the transmitting antenna as a high-frequency signal intended for transmission so as to be radiated as an electric wave from the transmitting antenna. A high-frequency signal received by the receiving antenna is given to the mixer. At the same time, the high-frequency signal outputted from the other output portion of the switching device is given as a local high-frequency signal, whereby the mixer mixes the high-frequency signal received by the receiving antenna and the local high-frequency signal and generates an intermediate-frequency signal. In this high-frequency transmitting/receiving apparatus in which an antenna for transmission and an antenna for reception are provided separately, one of the mixers of the invention is provided and therefore, also in a high-frequency transmitting/receiving apparatus in which an antenna for transmission and an antenna for reception are provided separately, by virtue of the mixer, mixing characteristics and the transmission characteristics of the mixer can be tuned appropriately in accordance with the property of the high-frequency detection element and the manner of mounting the high-frequency detection element. This makes it possible to realize a high-performance high-frequency transmitting/receiving apparatus that offers excellent reception sensitivity with stability.

The invention provides a high-frequency transmitting/receiving apparatus comprising:

a high-frequency oscillator for generating a high-frequency signal;

a branching device having two output portions, connected to the high-frequency oscillator, for branching the high-frequency signal given by the high-frequency oscillator and outputting the branched high-frequency signal components from one and the other of the two output portions, respectively;

a signal separating device having a first terminal, a second terminal, and a third terminal, for receiving at the first terminal the high-frequency signal intended for transmission from the one output portion of the branching device, for outputting from the second terminal the high-frequency signal intended for transmission inputted from the first terminal, and for outputting from the third terminal the high-frequency signal inputted from the second terminal;

a transmitting/receiving antenna connected to the second terminal; and

any one of the mixers mentioned above having, among the two input ends, one input end connected to the other output portion, and the other input end connected to the third terminal, for mixing the branched high-frequency signal component outputted from the other output portion and a high-frequency signal received by the transmitting/receiving antenna and generating an intermediate-frequency signal.

According to the invention, the high-frequency signals oscillated by the high-frequency oscillator is given to the branching device so as to be branched at the branching device, and the branched high-frequency signal components may be outputted from one output portion and the other output portion of the branching device. The high-frequency signal outputted from the one output portion is given to the first terminal of the signal separating device as a high-frequency signal intended for transmission. The signal separating device outputs the high-frequency signal intended for transmission given to the first terminal from the second terminal. The high-frequency signal intended for transmission is radiated as an electric wave from the transmitting/receiving antenna connected to the second terminal. A high-frequency signal received by the transmitting/receiving antenna is given to the second terminal, and the signal separating device outputs the high-frequency signal given to the second terminal from the third terminal. The signal separating device can separate the high-frequency signal intended for transmission given to the transmitting/receiving antenna and the high-frequency signal received by the transmitting/receiving antenna. The high-frequency signal outputted from the third terminal is given to the other input end of the mixer. At the same time, a local high-frequency signal is given from the other output portion of the branching device to one input end of the mixer, whereby the mixer mixes the high-frequency signal received by the transmitting/receiving antenna and the local high-frequency signal and generates an intermediate-frequency signal. In this high-frequency transmitting/receiving apparatus, one of the mixers of the invention is provided and therefore, by virtue of the mixer, the mixing characteristics and the transmission characteristics of the mixer can be tuned appropriately in accordance with the property of the high-frequency detection element and the manner of mounting the high-frequency detection element. This makes it possible to realize a high-performance high-frequency transmitting/receiving apparatus that offers excellent reception sensitivity with stability.

The invention provides a high-frequency transmitting/receiving apparatus comprising:

a high-frequency oscillator for generating a high-frequency signal;

a branching device connected to the high-frequency oscillator, for branching the high-frequency signal given by the high-frequency oscillator so that the branched high-frequency signal components may be outputted from one output portion and the other output portion thereof, respectively;

a transmitting antenna connected to the one output portion;

a receiving antenna; and

one of the mixers mentioned above having, among the two input ends, one input end connected to the other output portion of the branching device and the other input end connected to the receiving antenna, for mixing the branched high-frequency signal component outputted from the other output portion and a high-frequency signal received by the receiving antenna and generating an intermediate-frequency signal.

According to the invention, the high-frequency signal oscillated from the high-frequency oscillator is given to the branching device so as to be branched at the branching device, and the branched high-frequency signal components may be outputted from one output portion and the other output portion of the branching device. The high-frequency signal outputted from the one output portion is given to the transmission antenna as a high-frequency signal intended for transmission. The high-frequency signal intended for transmission is radiated as an electric wave from the transmitting antenna connected to the one output portion of the branching device. A high-frequency signal received by the receiving antenna is given to the other input end of the mixer. At the same time, a local high-frequency signal is given from the other output portion of the branching device to the one input end of the mixer, whereby the mixer mixes the high-frequency signal received by the receiving antenna and the local high-frequency signal and generates an intermediate-frequency signal. In this high-frequency transmitting/receiving apparatus, one of the mixers of the invention is provided and therefore, by virtue of the mixer, mixing characteristics and the transmission characteristics of the mixer can be tuned appropriately in accordance with the property of the high-frequency detection element and the manner of mounting the high-frequency detection element. This makes it possible to realize a high-performance high-frequency transmitting/receiving apparatus that offers excellent reception sensitivity with stability.

The invention provides a radar apparatus comprising:

one of the high-frequency transmitting/receiving apparatuses mentioned above; and

a distance information detector for detecting data on a distance to an object to be detected by processing the intermediate-frequency signal outputted from the high-frequency transmitting/receiving apparatus.

According to the invention, the radar apparatus is composed of: one of the high-frequency transmitting/receiving apparatuses described above; and the distance information detector for detecting data on a distance to an object to be detected by processing the intermediate-frequency signal outputted from the high-frequency transmitting/receiving apparatus. In this construction, the high-frequency transmitting/receiving apparatus of the invention included therein allows transmission of satisfactory high-frequency signals with high transmission power ON/OFF ratio and allows reception with excellent reception sensitivity. Thus, not only is it possible to detect an object to be detected swiftly without fail, but it is also possible to detect both nearby and far-off target objects successfully without fail.

The invention provides a radar-bearing vehicle comprising the radar apparatus mentioned above, which is used to detect an object to be detected.

According to the invention, the radar-bearing vehicle includes the radar apparatus mentioned above which is used to detect an object to be detected. Since the radar apparatus acts to detect swiftly an object to be detected, for instance, other vehicles or an obstruction on the road without fail, it is possible to exercise proper control of the vehicle and to give a driver a warning appropriately without causing abrupt actions in the vehicle to avoid collision.

### BRIEF DESCRIPTION OF THE DRAWINGS

Other and further objects, features, and advantages of the invention will be more explicit from the following detailed description taken with reference to the drawings wherein:

FIG. 1 is a schematic circuit diagram showing a mixer according to one embodiment of the invention;

FIG. 2 is a schematic view of the mixer according to another embodiment of the invention, with FIG. 2A showing a plan view of the mixer and FIG. 2B showing a perspective view of the principal part A of the mixer;

FIG. 3 is a plan view schematically showing an example of a high-frequency detection portion of the mixer shown in FIG. 2:

FIG. 4 is a schematic view of an example of a trimmable chip resistor for constituting a bias supply circuit shown in FIG. 1, with FIG. 4A showing a plan view of the trimmable chip resistor and FIG. 4B showing a side view thereof;

FIGS. 5A through 5E are schematic plan views showing some other examples of the trimming method for use with the trimmable chip resistor shown in FIG. 4;

FIG. 6 is a schematic block circuit diagram showing a high-frequency transmitting/receiving apparatus according to a first embodiment of the invention;

FIG. 7 is a plan view showing the high-frequency transmitting/receiving apparatus shown in FIG. 6;

FIG. 8 is a perspective view schematically showing an example of a substrate having a diode for use in a modulator of nonradiative dielectric line type;

FIG. 9 is a schematic block circuit diagram showing a high-frequency transmitting/receiving apparatus according to a second embodiment of the invention;

FIG. 10 is a plan view showing the high-frequency transmitting/receiving apparatus shown in FIG. 9;

FIG. 11 is a schematic block circuit diagram showing a high-frequency transmitting/receiving apparatus according to a third embodiment of the invention;

FIG. 12 is a schematic block circuit diagram showing a high-frequency transmitting/receiving apparatus according to a fourth embodiment of the invention;

FIG. 13 is a schematic block circuit diagram showing a high-frequency transmitting/receiving apparatus according to a fifth embodiment of the invention;

FIG. 14 is a schematic block circuit diagram showing a high-frequency transmitting/receiving apparatus according to a sixth embodiment of the invention;

FIG. 15 is a chart showing the intensity Pa₂ and Pb₂ of high-frequency signals Wa₂ and Wb₂, as observed in Implementation example of the high-frequency transmitting/receiving apparatus embodying the invention;

FIG. 16 is a chart showing transmission power ON/OFF ratio characteristics as observed in Implementation example of the high-frequency transmitting/receiving apparatus embodying the invention;

FIG. 17 is a partial cutaway perspective view showing a basic structure of a nonradiative dielectric line; and

FIG. 18 is a schematic block circuit diagram showing an example of a conventional high-frequency transmitting/receiving apparatus.

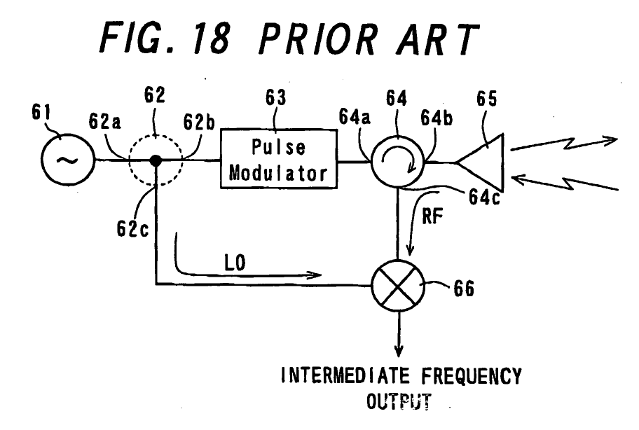

### DETAILED DESCRIPTION OF THE PREFERED EMBODIMENTS

Now referring to the drawings, preferred embodiments of the invention are described below.

At the outset, a mixer and a high-frequency transmitting/receiving apparatus having the mixer embodying the invention will be described in detail with reference to the accompanying drawings.

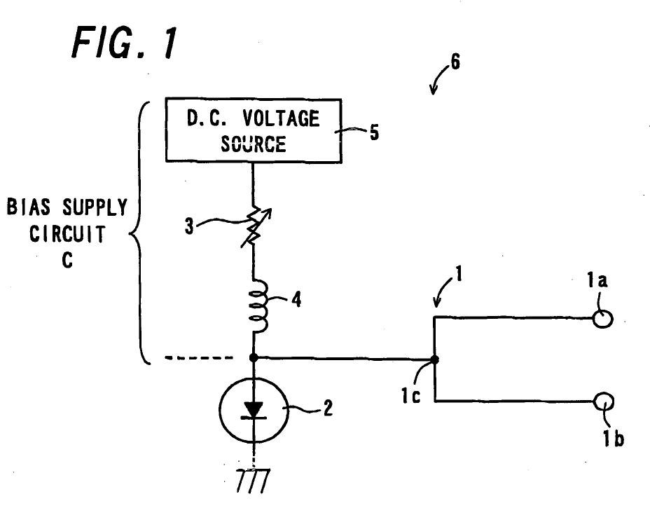

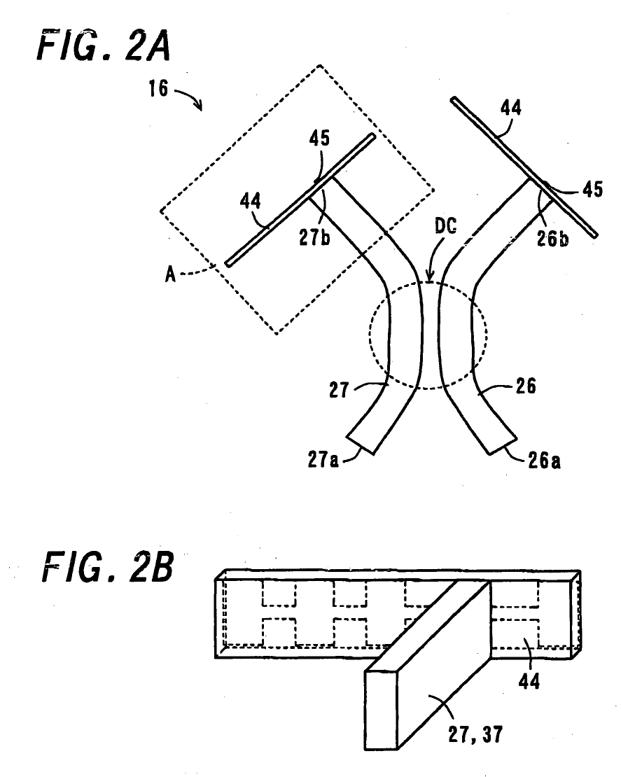

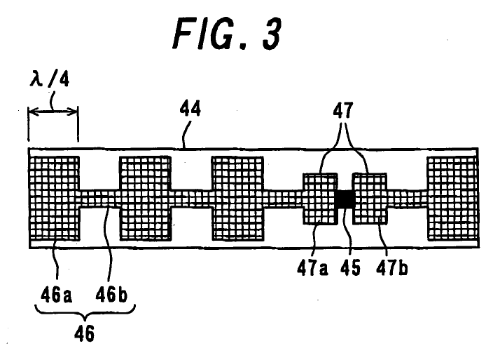

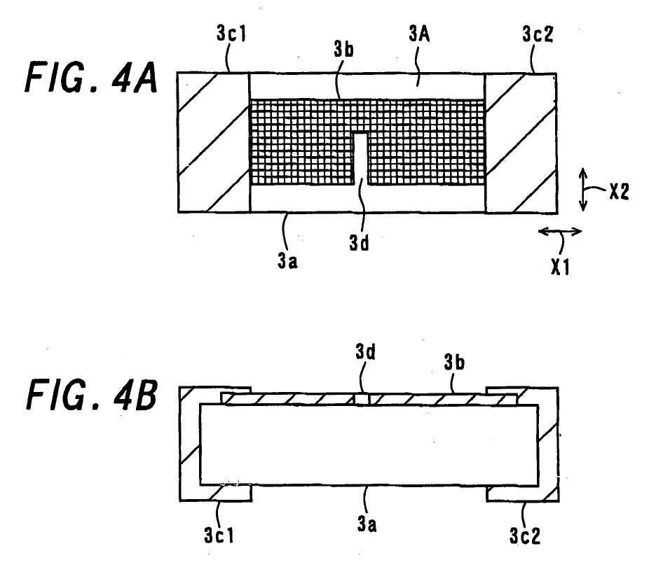

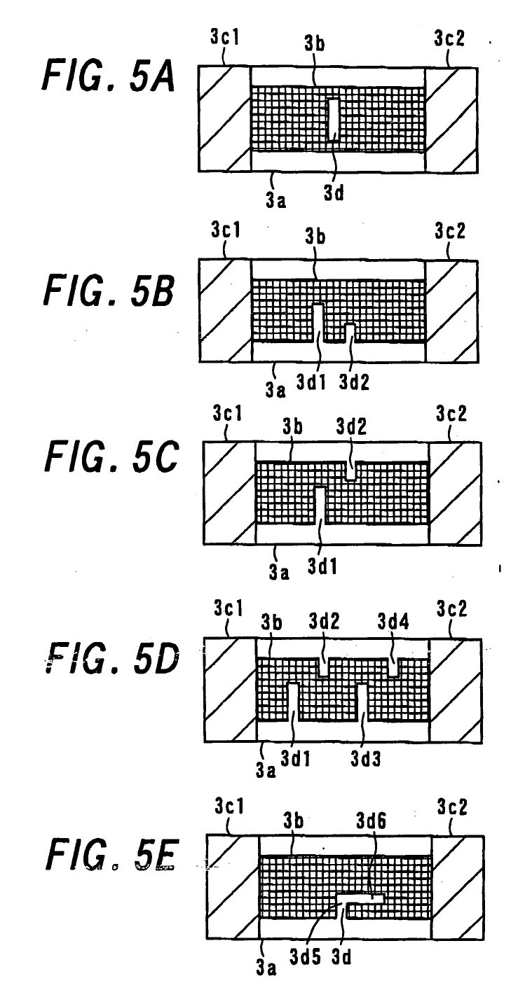

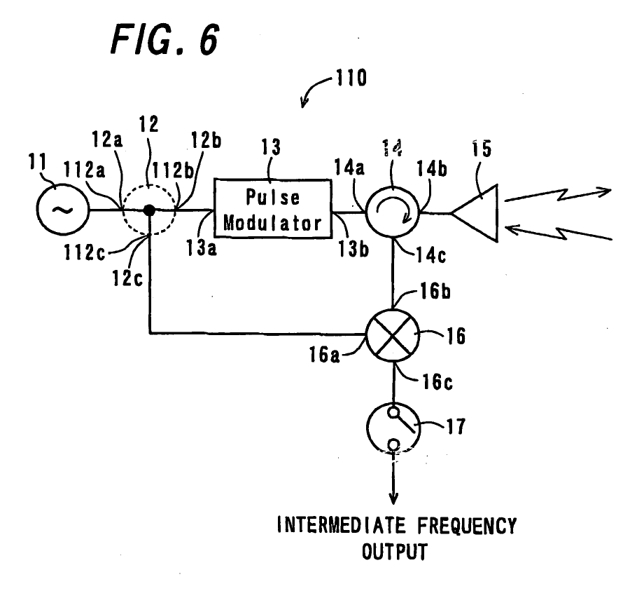

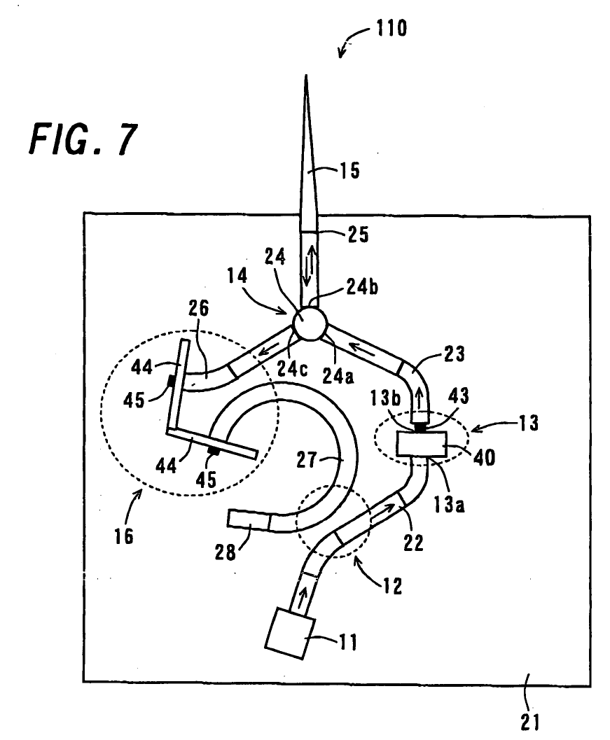

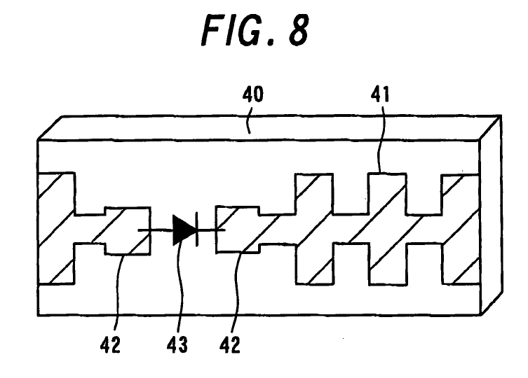

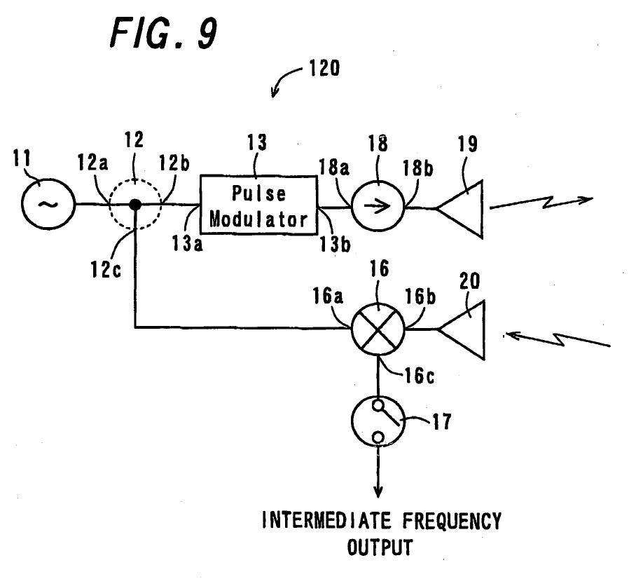

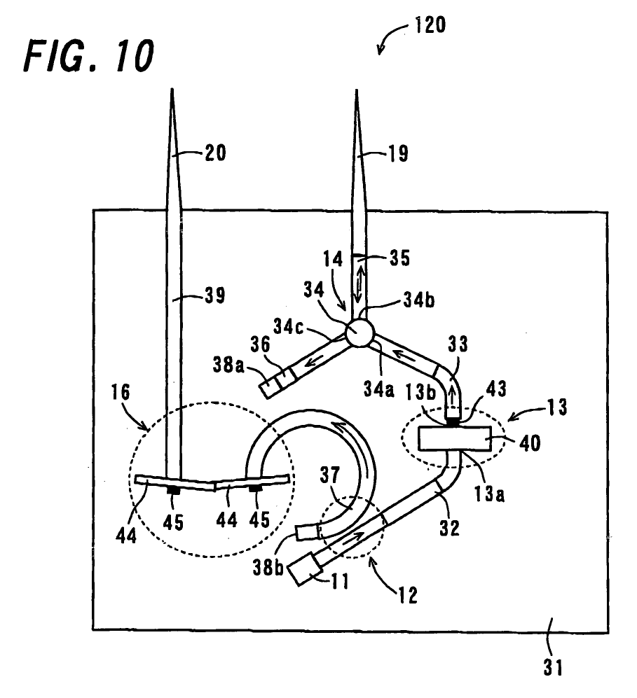

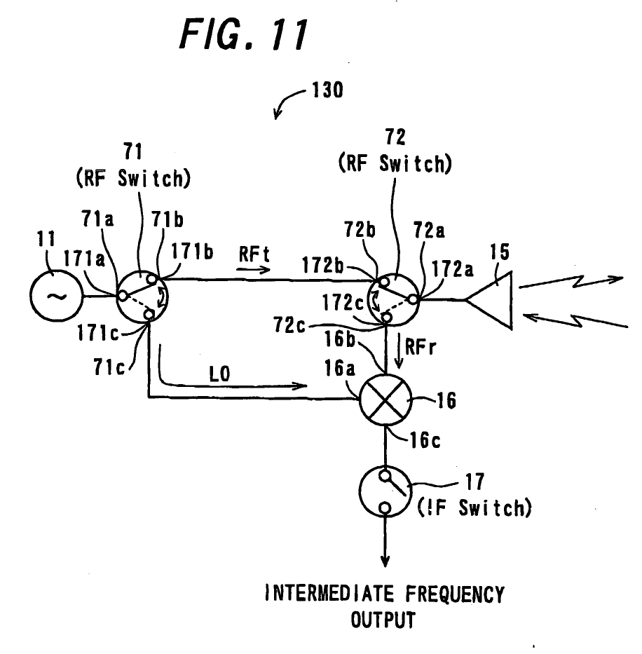

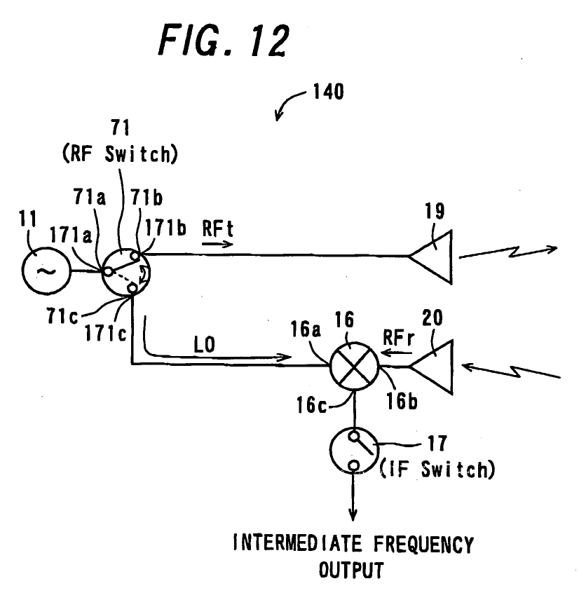

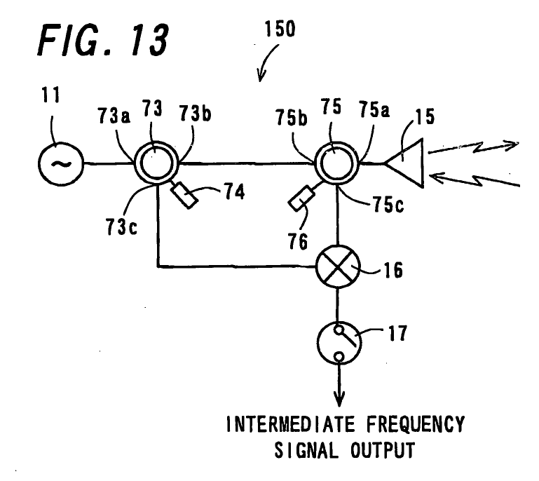

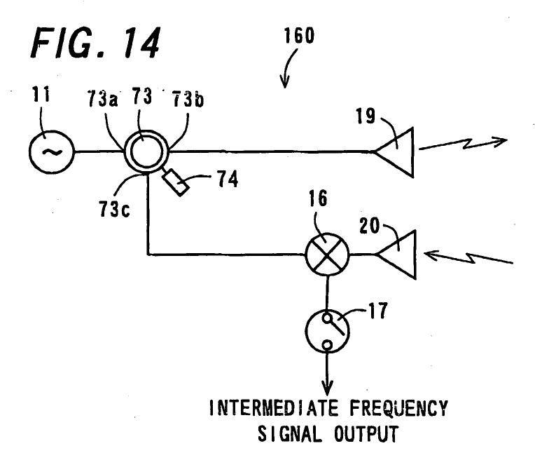

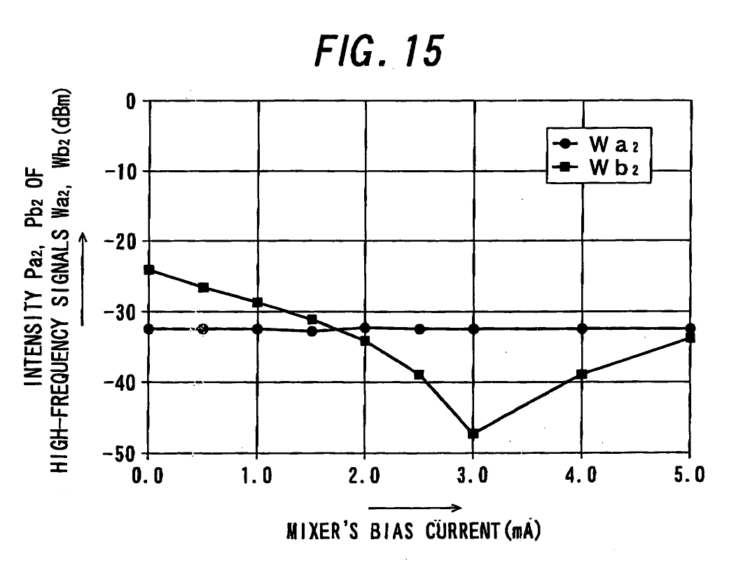

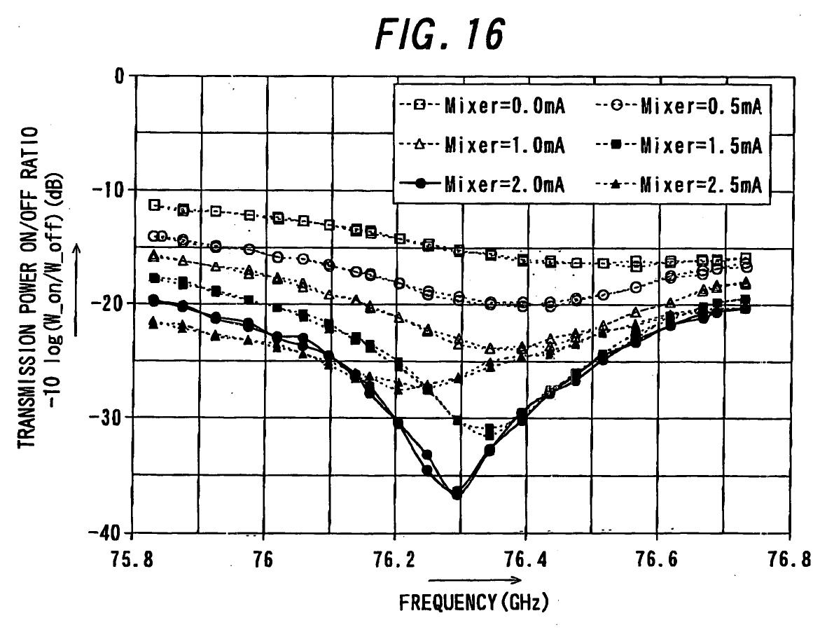

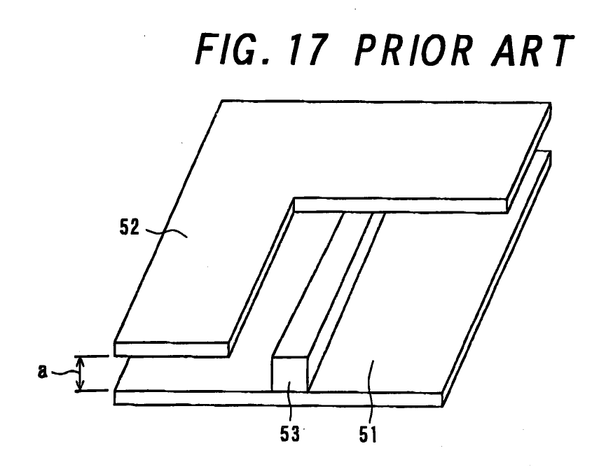

FIG. 1 is a schematic circuit diagram showing a mixer 6 according to one embodiment of the invention. FIG. 2 is a schematic view of the mixer 16 according to another embodiment of the invention, with FIG. 2A showing a plan view of the mixer and FIG. 2B showing a perspective view of the principal part A which is surrounded by a dotted line in the FIG. 2A. FIG. 3 is a plan view schematically showing an example of a high-frequency detection portion of the mixer shown 16 in FIG. 2. FIG. 4 is a schematic view of an example of a trimmable chip resistor for constituting a bias supply circuit C shown in FIG. 1, with FIG. 4A showing a plan view of the trimmable chip resistor and FIG. 4B showing a side view thereof. FIGS. 5A through 5E are schematic plan views showing some other examples of the trimming method for use with the trimmable chip resistor shown in FIG. 4. FIGS. 6 and 7 are a schematic block circuit diagram and a plan view, respectively, showing a high-frequency transmitting/receiving apparatus 110 according to a first embodiment of the invention. FIG. 8 is a perspective view schematically showing an example of a substrate having a diode for use in a modulator of nonradiative dielectric line type. FIGS. 9 and 10 are a schematic block circuit diagram and a plan view, respectively, showing a high-frequency transmitting/receiving apparatus 120 according to a second embodiment of the invention. FIG. 11 is a schematic block circuit diagram showing a high-frequency transmitting/receiving apparatus 130 according to a third embodiment of the invention. FIG. 12 is a schematic block circuit diagram showing a high-frequency transmitting/receiving apparatus 140 according to a fourth embodiment of the invention. FIG. 13 is a schematic block circuit diagram showing a high-frequency transmitting/receiving apparatus 150 according to a fifth embodiment of the invention. FIG. 14 is a schematic block circuit diagram showing a high-frequency transmitting/receiving apparatus 160 according to a sixth embodiment of the invention. FIG. 15 is a chart showing the intensity Pa₂ and Pb₂ of high-frequency signals Wa₂ and Wb₂, as observed in Implementation example of the high-frequency transmitting/receiving apparatus embodying the invention. FIG. 16 is a chart showing transmission power ON/OFF ratio characteristics as observed in Implementation example of the high-frequency transmitting/receiving apparatus embodying the invention. FIG. 17 is a partial cutaway perspective view showing the basic structure of a nonradiative dielectric line.

In FIGS. 1, 4, and 5, reference numeral 1 represents a coupler; 2 represents a Schottky-barrier diode provided as a high-frequency detection element; 3 represents a trimmable chip resistor provided as a pre-set variable resistor; 4 represents a choke inductor; and 5 represents a direct current voltage source. Moreover, symbol 3a represents a dielectric substrate; 3b represents a resistor layer; 3c1 and 3c2 each represent an electrode; and 3d and 3d1 to 3d4 each represent a trimming portion.

Further, in FIGS. 2, 3, and 6 to 14, reference numeral 11 represents a high-frequency oscillator; 12 represents a branching device, for example, directional coupler; 13 represents a modulator; 14 represents a circulator provided as a signal separating device; 15 represents a transmitting/receiving antenna; 16 represents a mixer; 17 represents a switch; 18 represents an isolator; 19 represents a transmitting antenna; 20 represents a receiving antenna; 21 and 31 each represent a lower parallel plate conductor; 22 and 32 each represent a first dielectric strip line; 23 and 33 each represent a second dielectric strip line; 24 and 34 each represent a ferrite plate provided as a magnetic substance; 25 and 35 each represent a third dielectric strip line; 26 and 36 each represent a fourth dielectric strip line; and 27 and 37 each represent a fifth dielectric strip line. Reference numeral 28 and symbols 38a and 38b each represent a nonreflective terminator. Reference numeral 39 represents a sixth dielectric strip line; 40 and 44 each represent a substrate; 41 and 46 each represent a choke-type bias supply line; 42 and 47 each represent a connection terminal; 43 represents a high-frequency modulation element; and 45 represents a high-frequency detection element. Symbol 12a represents an input end; 12b represents one output end; 12c represents the other output end; 13a and 18a each represent an input end; 13b and 18b each represent an output end; 14a, 24a, and 34a each represent a first terminal; 14b, 24b, and 34b each represent a second terminal; and 14c, 24c, and 34c each represent a third terminal. Moreover, reference numeral 71 represents an RF selector switch provided as a signal separating device; 72 represents a second RF selector switch provided as a switching device; 73, 74 represent a rat-race hybrid coupler, a termination resistor, respectively, serving as a branching device; and 75, 76 represent a second rat-race hybrid coupler, a termination resistor, respectively, serving as a signal separating device. Note that a pair of parallel plate conductors are not illustrated in FIG. 2 and that the upper parallel plate conductor is not illustrated in both FIG. 7 and FIG. 10.

In the mixer 6 according to one embodiment of the invention, as shown in the circuit diagram depicted in FIG. 1, the coupler 1 includes two input ends 1a and 1b, and one or two (as exemplified) output ends 1c. At the output end 1c is disposed the Schottky-barrier diode 2 acting as a high-frequency detection element. Connected to the Schottky-barrier diode 2 is the bias supply circuit C having the trimmable chip resistor 3 for controlling a bias current which passes through the Schottky-barrier diode 2. Moreover, in this construction, the coupler 1 is composed of a high-frequency transmission line such as a coplanar line, for synthesizing two high-frequency signals.

As described in more detail, the output end 1C of the coupler 1 is connected to an anode of the Schottky-barrier diode 2, and a cathode of the Schottky-barrier diode 2 is grounded. The bias supply circuit C is connected to an anode of the Schottky-barrier diode 2.

On the other hand, in the mixer 16 according to another embodiment of the invention, as shown in FIG. 2, a directional coupler DC includes two input ends 26a and 27a, and two output ends 26b and 27b. At each of the output ends 26b and 27b is disposed the Schottky-barrier diode 45 acting as a high-frequency detection element (corresponding to the Schottky-barrier diode 2 shown in FIG. 1). Connected to the Schottky-barrier diode 45 is the bias supply circuit C, such as that shown in FIG. 1. The bias supply circuit C comprises the trimmable chip resistor 3 for controlling a bias current which passes through the Schottky-barrier diode 45. In this construction, the directional coupler DC is composed of a nonradiative dielectric line that is constructed by having the dielectric strip line 26 and the dielectric strip line 27 sandwiched between a pair of parallel plate conductors (not shown). The dielectric strip line 26 and the dielectric strip line 27 are proximately placed or coupled so as to achieve electromagnetic coupling a mid-portion of the input end 26a and the output end 26b, and a mid-portion of the input end 27a and the output ends 27b. In regard to each of the dielectric strip lines 26 and 27, the nonradiative dielectric line has basically the same structure as that shown in the partial cutaway perspective view depicted in FIG. 17. Moreover, as shown in the plan view depicted in FIG. 3, the Schottky-barrier diode 45 is connected to the connection terminal 47 formed in the choke-type bias supply line 46. More specifically, the choke-type bias supply line 46 is composed of broad strips 46a and narrow strips 46b whose width is narrower than the broad strip, that are formed of a conductive layer formed on one surface of on the substrate 44. The broad strips 46a and the narrow strips 46b are alternately connected at an interval of λ/4 (where λ represents the wavelength of a high-frequency signal to be transmitted through the dielectric strip lines 26 and 27) periodically. The connection terminal 47 is interposed at a predetermined midway position of the choke-type bias supply line 46. In FIG. 3, in order to make an understanding easy, the broad strips 46a, the narrow strips 46b, and the connection terminal 47 are shown in a reticulated pattern. The broad strips 46a, the narrow strips 46b, and the connection terminal 47 are formed so as to have the same centers in a width direction. The width direction is a direction perpendicular to an extending direction of the line 46 and a thickness direction of the line 46, The broad strips 46a, the narrow strips 46b, and the connection terminal 47 have rectangular profiles as observed from one side in a thickness direction. One connection terminal 47a is formed in a single body with the broad strips 46a and the narrow strips 46b which are connected on an opposite side of the Schottky-barrier diode 45 of one connection terminal 47a. The other connection terminal 47b is formed in a single body with the broad strips 46a and the narrow strips 46b which are connected on an opposite side of the Schottky-barrier diode 45 of one connection terminal 47a. The substrate 44 connected with the Schottky-barrier diode 45 is so arranged that high-frequency signals respectively outputted to the output ends 26b and 27b of the dielectric strip lines 26 and 27 enter the Schottky-barrier diode 45.

Moreover, in the constructions thus far described, as shown in the circuit diagram depicted in FIG. 1, the bias supply circuit C is provided with the choke inductor 4 and the direct current voltage source 5. The choke inductor 4, the trimmable chip resistor 3, and the direct current voltage source 5 are connected to the Schottky-barrier diode 2 one after another. In other words, the choke inductor 4 is connected to the anode of the Schottky-barrier diode 2, and the trimmable chip resistor 3 is connected between the choke inductor 4 and the direct current voltage source 5. Note that the choke-type bias supply line 46 corresponds to the choke inductor 4. The direct current voltage source is constituted by a constant voltage source which outputs a predetermined direct voltage.

As shown in FIG. 4, for example, the trimmable chip resistor 3 is composed of the dielectric substrate 3a made of a dielectric substance such as alumina ceramics. On the dielectric substrate 3a, that is one surface 3A of the dielectric substrate 3a in a thickness direction, is formed the resistor layer 3b made of a resistor material such as an Ni—Cr (Nickel-Chrome) alloy. At both end portions of the resistor layer 3b are formed connectedly the electrodes 3c1 and 3c2 so as to cover both end portions of the dielectric substrate 3a. The resistor layer 3b of the trimmable chip resistor 3 is radiated with laser light emitted from a YAG (Yttrium Aluminum Garnet) laser or the like device to oxidize part of the resistor layer 3b by an appropriate area, whereby the trimming portion 3d formed of an insulating metal oxide is formed. In this way, the resistance between the electrodes 3c1 and 3c2 is caused to vary. The both end portions of the resistor layer 3b are, in other words, both end portions in a predetermined direction along the one surface 3A of the dielectric substrate 3a in the resistor layer 3b. Here are the both end portions in a longitudinal direction X1. The both end portions of the resistor layer 3a are, in other words, both end portions in a predetermined direction along the one surface 3A of the dielectric substrate 3a in the resistor layer 3a. Here are the both end portions in a longitudinal direction X1. The electrodes 3c1, 3c2 are formed of metal materials having lower resistance than the resistor layer 3b, and formed by plating solder, aluminum, copper or the like. The resistor layer 3b is realized by a metal thin film having a parallelepiped form. The resistor layer 3b is formed in a region not including a margins on one surface 3A of the dielectric substrate 3a in a thickness direction. The both end portions of the resistor layer 3b in a longitudinal direction are each in contact with the electrodes 3c1, 3c2.

The trimmable chip resistor 3 covers the resistor layer 3b between the electrodes 3c1 and 3c2, and may have a protective film having electrical isolation. The protective film passes around 99% of a light of the YAG laser therethrough. By providing such a protective film, it is unnecessary to separately perform a process for protecting the resistor layer 3b after trimming. This facilitates an aftertreatment. Moreover, the resistor layer 3b is protected by the protective film. Consequently, the resistance is prevented from being varied so that a stable resistance is maintained in the trimmable chip resistor 3.

According to the mixers 6, 16 embodying the invention as shown in FIGS. 1 to 4, just like the mixer of conventional design, high-frequency signals inputted from the two input ends 1a and 1b (26a and 27a) are mixed together (mixing) so as to generate an intermediate-frequency signal. In general, mixing characteristics, as well as the transmission characteristics of the mixer, are dependent upon a bias current passing through the Schottky-barrier diode 2 (45). In light of this, in the invention, the trimmable chip resistor 3 is arranged between the direct current voltage source 5 and the Schottky-barrier diode 2 (45), as a pre-set variable resistor for controlling the bias current. By adjusting the resistance of the trimmable chip resistor 3 properly through trimming or the like technique, it is possible to control the bias current so as to keep the mixing characteristics and the transmission characteristics of the mixer tuned optimally (tuning).

Note that, in the invention, the mixing characteristics refer mainly to conversion gain characteristics defined by the relative intensity ratio between high-frequency signals subjected to mixing and an intermediate-frequency signal to be outputted. On the other hand, the transmission characteristics of the mixer refer to the transmission characteristics of high-frequency signals passing through the two input ends of the mixer.

Instead of the trimmable chip resistor 3 such as shown herein, it is also possible to use another type of pre-set variable resistor, for example, a mechanical trimmer resistor or potentiometer such as a rotary-type or contact-type potentiometer. In either case, substantially the same effect can be achieved. However, the use of the trimmable chip resistor 3 is desirable in that no resistance drift takes place in spite of occurrence of external vibration, and that it offers high reliability against temperature and moisture variation.

Specifically, the trimmable chip resistor 3 is designed as follows. As shown in FIG. 4, for example, YAG laser light is applied in parallel with a width direction X2 of the resistor layer 2b to one electrode 3c1, 3c2-free outer edge of the resistor layer 3b, from the outside, to form a linear oxidized portion acting as the trimming portion 3d. The resistance of the trimmable chip resistor 3 varies with the area of the trimming portion 3d formed in the shape of a linear oxidized portion or the like shape. As the area of the trimming portion 3d is increased, the area of the cross section of the resistor layer 3b through which a current passes is decreased, thereby increasing the resistance. When the resistor layer 3b is oxidized, for example in a region where the laser light is applied, all parts from one surface to the other surface of the resistor layer 3b in a thickness direction may be oxidized, and in a region where the laser light is applied, only one surface portion of the resistor layer 3b in a thickness direction is oxidized.

When the resistance of the trimmable chip resistor 3 is adjusted, the initial value of the resistance is generally set to be relatively small in advance within a desired adjustment range, so that the resistance may be adjusted to increase gradually. Moreover, before increasing the area of the trimming portion 3d by proceeding linear cutting, the width of the trimming portion 3d is set at a predetermined value in correspondence with the spot size of the YAG laser light. Then, as the YAG laser light is allowed to scan in one axial direction, the area of the trimming portion 3d is increased correspondingly in the scanning direction. By applying the YAG laser light repeatedly to the same part under pulsed operation prior to a subsequent scanning, it is possible to exercise resistance control (trimming) with high accuracy.

In the embodiment, a part of the resistor layer 3b is oxidized, thereby varying the resistance of the resistor layer 3b. However, in another embodiment of the invention, a part of the resistor layer 3b may be cut away by a laser, thereby varying the resistance of the resistor layer 3b.

The trimming portion 3d is not limited to the linear oxidized portion as shown in FIG. 4. For example, as shown in the plan view depicted in FIG. 5A, the trimming portion 3d may be obtained by forming a similar linear oxidized portion in the midsection of the resistor layer 3b like an island. Likewise, in the example shown in FIG. 5B, a similar linear oxidized portion is formed as a first oxidized portion 3d1, and also another linear oxidized portion is formed as a second oxidized portion 3d2 at a position slightly away from the first oxidized portion 3d1 (double-oxidized configuration). The second oxidized portion 3d2 is made shorter than the first oxidized portion 3d1.

An extending direction of the first oxidized portion 3d1 and an extending direction of the second oxidized portion 3d2 are in parallel. The first oxidized portion 3d1 and the second oxidized portion 3d2 are formed so as not to be connected to each other. It is desirable that an end of the first oxidized portion 3d1 on the second oxidized portion 3d2 side and an end of the second oxidized portion 3d2 on the first oxidized portion 3d1 side are formed away at a predetermined distance, in a direction perpendicular to the extending direction of the first oxidized portion 3d1 and second oxidized portion 3d2 and an thickness direction of the resistor layer 2b, that is the longitudinal direction X1 of the resistor layer 2b.

In the example shown in FIG. 5C, in contrast to the double-oxidized configuration as shown in FIG. 5B, the second oxidized portion 3d2 is formed on the opposite side of the resistor layer 3b to the first oxidized portion 3d1. In the example shown in FIG. 5D, in addition to a pair of linear oxidized portions 3d1 and 3d2 shown in FIG. 5C as the double-oxidized configuration, another pair of linear oxidized portions 3d3 and 3d4 may be formed in a comb-teeth shape (serpentine-oxidized configuration). By forming such trimming portions 3d and 3d1 to 3d4 as shown in FIGS. 5B to 5D, it is possible to achieve trimming-based adjustment with higher accuracy. This is because the resistance can be determined with greater precision in the presence of the second oxidized portions 3d2 and 3d4. By forming the trimming portion 3d in such a manner, the line length of the resistor layer 3b can be increased, and therefore the resistance can be increased.

Moreover, as shown in FIG. 5E, the trimming portion 3d can also be made as an L-shaped oxidized portion composed of a first linear oxidized portion 3d5 formed in parallel with the width direction X2, and a second linear oxidized portion 3d6 which is formed by bending a direction for scanning the laser light at almost right angle in relation to the first linear oxidized portion 3d5 on the way and extends in the longitudinal direction of the resistor layer 3b. A length of the first linear oxidized portion 3d5 in parallel with the width direction X2 of the resistor layer 3b is selected to be equal to or less than one half of a length of the resistor layer 3b in the width direction X2 or shorter. Moreover, a length of the third linear oxidized portion 3d6 in an extending direction, in other words, a length of the second linear oxidized portion 3d6 in parallel with the longitudinal direction X1 of the resistor layer 3b is selected to be longer than a length of the first linear oxidized portion 3d5 in parallel with the width direction X2 of the resistor layer 3b.

In this case, a stress placed on the resistor layer 3b can be alleviated; wherefore the resistor layer 3b is less prone to a micro crack. This helps reduce a resistance drift that occurs under the influence of the micro crack.

Note that, although trimming can be achieved in a sufficiently wide adjustment range with use of a single trimmable chip resistor 3, it is also possible to use a plurality of trimmable chip resistors 3 connected in series or in parallel with one another.

The trimmable chip resistors 3 is provided so as to be exposed outside when the mixer is attached to the high-frequency transmitting/receiving apparatus. This makes it possible to vary the resistance of the trimmable chip resistors 3 in a state where the mixer is attached to the high-frequency transmitting/receiving apparatus.

According to the embodiments of the mixer 6, 16 of the invention, by virtue of the trimmable chip resistor 3 provided as a pre-set variable resistor, in accordance with the Schottky-barrier diode (2, 45) acting as a high-frequency detection element such as the property of noise generated by the resistance component of the high-frequency detection element and the manner of mounting the Schottky-barrier diode (2, 45), a bias current is set at an appropriate value at the time of adjusting characteristics such as the mixing characteristics and the transmission characteristics of the mixer, and, at all other times such as an occasion where the mixer has been incorporated into a product, the bias current is maintained at the preset value. In this construction, in contrast to the case of controlling the electrical length of the adjustment mechanism formed so as to extend from the high-frequency detection element arranged in the high-frequency transmission line, not only is it possible to reduce a mechanical play present in the structure, but it is also possible to stabilize the working condition after the setting. As a result, the characteristics including the mixing characteristics and the transmission characteristics of the mixer can be tuned with high accuracy and stability. Moreover, in the absence of a movable part, the trimmable chip resistor 3 is able to act to maintain a determined resistance with stability in spite of occurrence of an external force such as vibration after adjustment. Thus, the trimmable chip resistor 3 is suitable for use as a pre-set variable resistor from a stable tuning standpoint.

Note that, in the invention, instead of the trimmable chip resistor 3 such as shown herein, it is also possible to use another type of pre-set variable resistor as described previously, so long as it demonstrates the following properties: its resistance can be adjusted to vary arbitrarily; a preset value is prevented from varying inadvertently; and the resistance is adjustable at least dozens of times. As the pre-set variable resistor, it is preferable to use an irreversible resistor such as the trimmable chip resistor 3.

In the mixer 6, 16 embodying the invention, the high-frequency transmission line is not limited to a coplanar line or a nonradiative dielectric line, but may be of another configuration such as a strip line, a micro-strip line, a coplanar line having a ground, a slot line, a waveguide, or a dielectric waveguide.

Next, the high-frequency transmitting/receiving apparatus 110 according to the first embodiment of the invention will be described. As shown in the block circuit diagram depicted in FIG. 6, the high-frequency transmitting/receiving apparatus is composed of: a high-frequency oscillator 11 for generating a high-frequency signal; a branching device 12 connected to the high-frequency oscillator 11, for branching the high-frequency signal so that the branched high-frequency signal components may be outputted to one output end 12b and the other output end 12c thereof, respectively; a modulator 13 connected to the one output end 12b of the branching device 12, for modulating the high-frequency signal component branched at the one output end 12b so as to output a high-frequency signal intended for transmission; a circulator 14 formed of a magnetic substance having a first terminal 14a, a second terminal 14b, and a third terminal 14c that are arranged about the periphery of the magnetic substance, of which the first terminal 14a receives an output from the modulator 13, wherein a high-frequency signal inputted from one of the terminals is outputted from the other adjoining terminal in turn, in order from the first through third terminals; a transmitting/receiving antenna 15 connected to the second terminal 14b of the circulator 14; and a mixer 16, which is any one of the mixers accomplished by way of the embodiments of the invention. The mixer 16 includes two input ends 16a and 16b that are each connected between the other output end 12c of the branching device 12 and the third terminal 14c of the circulator 14, for mixing the high-frequency signal component branched at the other output end 12c and a high-frequency signal received by the transmitting/receiving antenna 15 so as to generate an intermediate-frequency signal.

In other words, the branching device 12 has two output portions 112b, 112c. An input portion 112a of the branching device 12 is connected to the high-frequency oscillator 11. The branching device 12 branches the high-frequency signal given by the high-frequency oscillator 11 so that the branched high-frequency signal components may be outputted from one output portion 112b and the other output portion 112c thereof, respectively. The modulator 13 is connected to the one output portion 112c and modulates the branched high-frequency signal component so as to output a high-frequency signal intended for transmission to the one output portion. When the high-frequency signal intended for transmission is given from the modulator 13 to the first terminal 14a, the circulator 14 acting as a signal separating device outputs the high-frequency signal intended for transmission which is inputted from the first terminal 14a, from the second terminal 14b and outputs a high-frequency signal which is inputted from the second terminal 14b, from the third terminal. In the mixer 16, one input end 16a is connected to the other output portion 112c of the branching device 12, and the other input end 12b is connected to the third terminal 14c. The mixer 16 mixes the branched high-frequency signal component outputted from the other output portion 112c and the high-frequency signal received by the transmitting/receiving antenna 15 so as to generate an intermediate frequency signal.

In the high-frequency transmitting/receiving apparatus, it is preferable that a transmission coefficient between the two input ends 16a and 16b of the mixer 16 is determined in such a way that the following expression holds: Pa₂=Pb₂. Specifically, a high-frequency signal passing through the modulator 13 placed in an OFF state is defined as Wa₂, and a high-frequency signal that has been transmitted from the other output portion 112c of the branching device 12 to the output end 13b of the output portion of the modulator 13 by way of the mixer 16 and the circulator 14 and then reflected from the output end 13b of the modulator 13 is defined as Wb₂. The intensity of the high-frequency signal Wa₂ is represented by Pa₂, whereas the intensity of the high-frequency signal Wb₂ is represented by Pb₂. Under these conditions, the transmission coefficient is adjusted so as for the expression Pa₂=Pb₂ to hold.

In the high-frequency transmitting/receiving apparatus, it is also preferable to determine the distance (line length) between one output end 12b of the branching device 12 and the modulator 13, or the distance (line length) between the output end 12c of the other output portion 112c of the branching device 12 and the output end 13b of the modulator 13, with the mixer 16 and the circulator 14 lying therebetween, in such a way that the following expression holds: δ=(2N+1)·π (N represents an integer), where δ represents the difference in phase between the high-frequency signals Wa₂ and Wb₂ at a center frequency. In order for the phase difference δ to be given by the expression δ=(2N+1)·π, the line length of the first dielectric strip line 22 which connects the high-frequency oscillator 11 and the modulator 13 and constitutes a part of the branching device 12 as shown in FIG. 7, is increased while the line length of the second dielectric strip line 23 which connects the modulator 13 and the circulator 14, is decreased correspondingly, or the line length of the second dielectric strip line 23 is increased while the line length of the first dielectric strip line 22 is decreased correspondingly. In this case, there is no need to change the arrangement of the circuit elements other than the modulator 13, thereby facilitating the adjustment. Note that, at this time, it is necessary to maintain the position of the mutually adjacent or coupled portions of the first dielectric strip line 22 and the fifth dielectric strip line 27 (the section for constituting the branching device 12).

Moreover, the high-frequency transmitting/receiving apparatus 110 of the invention shown in FIG. 6 employs a nonradiative dielectric line as a high-frequency transmission line for providing connection among the constituent elements. The nonradiative dielectric line in use has basically the same structure as that shown in the partial cutaway perspective view depicted in FIG. 17.

More specifically, as shown in the plan view depicted in FIG. 7, the high-frequency transmitting/receiving apparatus 110 of the invention shown in FIG. 6 is composed of a pair of parallel plate conductors 21 disposed at an interval equal to or less than one half of the wavelength of a high-frequency signal (one of the parallel plate conductors is not illustrated). Arranged between the two parallel plate conductors 21 are: a first dielectric strip line 22; the high-frequency oscillator 11 connected to one end of the first dielectric strip line 22, for frequency-modulating a high-frequency signal outputted from a high-frequency diode and putting out the frequency-modulated high-frequency signal that has propagated through the first dielectric strip line 22; the modulator 13 having an input end 13a and an output end 13b that is connected to the other end of the first dielectric strip line 22, for allowing the high-frequency signal to reflect toward the input end 13a or pass toward the output end 13b in response to a pulse signal; a second dielectric strip line 23 which has its one end connected to the output end 13b of the modulator 13; the circulator 14, formed of a ferrite plate 24 disposed in parallel with the parallel plate conductors 21, having a first terminal 24a, a second terminal 24b, and a third terminal 24c that are arranged about the periphery of the ferrite plate 24 and respectively act as high-frequency signal input and output ends, of which the first terminal 24a is connected to the other end of the second dielectric strip line 23, wherein a high-frequency signal inputted from one of the terminals is outputted from the other adjoining terminal in turn, in order from the first through third terminals; a third dielectric strip line 25 and a fourth dielectric strip line 26, arranged radially about the periphery of the ferrite plate 24 constituting the circulator 14, that have their one ends connected to the second terminal 24b and the third terminal 24c, respectively; the transmitting/receiving antenna 15 connected to the other end of the third dielectric strip line 25; a fifth dielectric strip line 27 which has its mid-portion placed in the proximity of or coupled with the mid-portion of the first dielectric strip line 22, in other words, which has its mid portion in an extending direction placed in the proximity of or coupled with a mid portion of the first dielectric strip line 22 in an extending direction, for branching and transmitting part of a high-frequency signal propagating through the first dielectric strip line 22; a nonreflective terminator 28 connected to one high-frequency oscillator ll-side end of the fifth dielectric strip line 27; and the mixer 16, which is any one of the mixers accomplished by way of the embodiments of the invention. The mixer 16 is connected between the other end of the fourth dielectric strip line 26 and the other end of the fifth dielectric strip line 27, for mixing a high-frequency signal inputted from the fifth dielectric strip line 27 and a high-frequency signal inputted from the circulator 14 after being received by the transmitting/receiving antenna 15 so as to generate an intermediate-frequency signal.

In this construction, it is preferable that a transmission coefficient between the two input ends 16a and 16b of the mixer 16 is determined in such a way that the following expression holds: Pa₂=Pb₂. Specifically, a high-frequency signal that has been inputted to the second dielectric strip line 23 after passing through the modulator 13 placed in an OFF state, that is the modulator 13 in a state where a bias voltage is not applied, is defined as Wa₂, and a high-frequency signal that has been transmitted from the mutually adjacent or coupled portions of the first dielectric strip line 22 and the fifth dielectric strip line 27 as well as the mutually adjacent or coupled portions of the fifth dielectric strip line 27 and the fourth dielectric strip line 26 to the output end 13b of the modulator 13 through the circulator 14, then reflected from the output end 13b of the modulator 13, and eventually inputted to the second dielectric strip line 23 is defined as Wb₂. The intensity of the high-frequency signal Wa₂ is represented by Pa₂, whereas the intensity of the high-frequency signal Wb₂ is represented by Pb₂. Under these conditions, the transmission coefficient is adjusted so as for the expression Pa₂=Pb₂ to hold. The transmission coefficient between the two input ends 16a and 16b of the mixer 16 can be adjusted to a desired value by utilizing the tuning function of the mixer of the invention.

In this construction, it is also preferable that the distance (line length) between the mutually adjacent or coupled portions of the first dielectric strip line 22 and the fifth dielectric strip line 27 (the section for constituting the branching device 12) and the other end of the first dielectric strip line 22 (corresponding to the distance (line length) between the branching device 12 and the modulator 13) or the sum of the distance (line length) between the mutually adjacent or coupled portions of the first dielectric strip line 22 and the fifth dielectric strip line 27 and the other end of the fifth dielectric strip line 27; the line length of the fourth dielectric strip line 26; and the line length of the second dielectric strip line 23 (corresponding to the distance (line length) between the mixer 16-side portion of the branching device 12 and the modulator 13) is determined in such a way that the following expression holds: δ=(2N+1)·π. Specifically, a high-frequency signal passing through the modulator 13 placed in an OFF state is defined as Wa₂, and a high-frequency signal that has been transmitted from the mutually adjacent or coupled portions of the first dielectric strip line 22 and the fifth dielectric strip line 27 to the output end 13b of the modulator 13 through the mixer 16, the fourth dielectric strip line 26, and the circulator 14, and then reflected from the output end 13b of the modulator 13 is defined as Wb₂. δ represents the difference in phase between the high-frequency signals Wa₂ and Wb₂ at a center frequency. Under these conditions, the line length is adjusted so as for the expression δ=(2N+1)·π to hold. Note that, as described above, the first and fifth dielectric strip lines 22 and 27 constitute the branching device 12 at their mutually adjacent or coupled portions.

In FIG. 7, the first terminal 24a, the second terminal 24b, and the third terminal 24c correspond to the first terminal 14a, the second terminal 14b, and the third terminal 14c shown in FIG. 6, respectively.

In this construction, the modulator 13 is designed as follows. As shown in the perspective view depicted in FIG. 8, the connection terminal 42 is arranged at some midway position of the choke-type bias supply line 41 formed on one surface of the substrate 40 in a thickness direction, and the diode 43 acting as a high-frequency modulation element is connected to the connection terminal 42, whereby a high-frequency modulator is fabricated. The high-frequency modulator is interposed between the first dielectric strip line 22 and the second dielectric strip line 23 so as for a high-frequency signal outputted from the first dielectric strip line 22 to enter the diode 43. The choke-type bias supply line 41 has a similar form to the above-described choke-type bias supply line 46 shown in FIG. 3. In FIG. 8, in order to make an understanding easy, the choke-type bias supply line 41 is shown with diagonal lines. The diode 43 acting as a high-frequency modulation element may be realized by using a PIN diode. Instead of the diode 43, it is also possible to use a transistor or micro-wave monolithic integrated circuit (MMIC).

In the invention, such a transmissive modulator as described just above is suitable for use as the modulator 13 of the high-frequency transmitting/receiving apparatus. Instead of the transmissive modulator, it is also possible to use a switching device that allows transmission and reflection of high-frequency signals, such as a semiconductor switch or a MEMS (Micro Electro Mechanical System) switch.

The high-frequency transmitting/receiving apparatus 110 of the invention shown in FIGS. 6 and 7 is similar to the conventional high-frequency transmitting/receiving apparatus in terms of operation. However, in the high-frequency transmitting/receiving apparatus 110, by virtue of the mixer 16 of the invention, the mixing characteristics and the transmission characteristics of the mixer can be tuned appropriately in accordance with the property of the Schottky-barrier diode 45 acting as a high-frequency detection element and the manner of mounting the Schottky-barrier diode 45. This makes it possible to realize a high-performance high-frequency transmitting/receiving apparatus that offers excellent reception sensitivity with stability.

As another advantage, the transmission coefficient between the two input ends 16a and 16b of the mixer 16 is determined in such a way that the expression Pa₂=Pb₂ holds. Specifically, a high-frequency signal passing through the modulator 13 placed in an OFF state is defined as Wa₂, and a high-frequency signal that has been transmitted from the other output end 12c of the branching device 12 to the output end 13b of the modulator 13 by way of the mixer 16 and the circulator 14 and then reflected from the output end 13b of the modulator 13 is defined as Wb₂. The intensity of the high-frequency signal Wa₂ is represented by Pa₂, whereas the intensity of the high-frequency signal Wb₂ is represented by Pb₂. Under these conditions, the transmission coefficient is adjusted so as for the expression Pa₂=Pb₂ to hold. In this case, the high-frequency signals Wa₂ and Wb₂ interfere with each other thereby to cause attenuation. This makes it possible to realize a high-frequency transmitting/receiving apparatus that is remarkable for constructional simplicity yet offers excellent transmission and reception performance, with high transmission power ON/OFF ratio, by preventing part of a high-frequency signal intended for transmission from being transmitted as an unwanted signal when the modulator 13 is kept in an OFF state.

By substantially equating the intensity Pa₂ of the high-frequency signal Wa₂ (unit: watt) with the intensity Pb₂ of the high-frequency signal Wb₂ (unit: watt), it is possible to cause the high-frequency signals Wa₂ and Wb₂ to interfere and weaken with each other effectively. That is, when the high-frequency signals Wa₂ and Wb₂ are synthesized, the resultant signal intensity is far smaller than the actual sum of the intensity Pa₂ and Pb₂: Pa₂+Pb₂. For this reason, it is desirable to satisfy the expression Pa₂=Pb₂. Theoretically, such a phenomenon takes place when two high-frequency signals interfere with each other. On the other hand, if the relationship between Pa₂ and Pb₂ is given by: Pa₂≠Pb₂, the high-frequency signals Wa₂ and Wb₂ interfere with each other insufficiently, with the result that there is not much difference between the signal intensity as observed when the high-frequency signals Wa₂ and Wb₂ are synthesized and the actual sum of the intensity Pa₂ and Pb₂: Pa₂+Pb₂. This makes it impossible to suppress production of an unwanted high-frequency signal when the modulator 13 is kept in an OFF state, leading to failure of attaining high ON/OFF ratio.

As still another advantage, the distance (line length) between one output end 12b of the branching device 12 and the modulator 13, or the distance (line length) between the other output end 12c of the branching device 12 and the output end 13b of the modulator 13, with the mixer 16 and the circulator 14 lying therebetween, is determined in such a way that the following expression holds: δ=(2N+1)·π (N represents an integer): where δ represents the difference in phase between the high-frequency signals Wa₂ and Wb₂ at a center frequency. In this case, in the region between the output end 13b of the modulator 13 and the circulator 14, the high-frequency signals Wa₂ and Wb₂ are synthesized in phase opposition and cancel out each other thereby to cause attenuation most effectively. This makes it possible to realize a high-frequency transmitting/receiving apparatus that offers excellent transmission and reception performance, with high transmission power ON/OFF ratio, by effectively preventing part of a high-frequency signal intended for transmission from being transmitted as an unwanted signal when the modulator 13 is kept in an OFF state.

Further, in the above constitution, it is preferable that an output end of the mixer 16 is provided with a switch 17 which performs opening/closing (switching) in accordance with an open/close controlling signal from the outside. When the switch 17 for performing opening/closing (switching) in accordance with the open/close controlling signal from the outside is provided on the output end of the mixer 16, that is the output portion 16c for outputting the generated intermediate frequency signal, even if, for example, an insufficient isolation between the first terminal 14a of the circulator 14 and the third terminal 14c causes a leakage of a part of the high-frequency signal intended for transmission into the third terminal 14c of the circulator 14, it is possible to operate the switch 17 so as to cut off such an intermediate frequency signal in order not to output the intermediate frequency signal to the leaked high-frequency signal and therefore, the high-frequency signal to be received can be made to be easily identified.

Next, the high-frequency transmitting/receiving apparatus 120 according to the second embodiment of the invention will be described. As shown in the block circuit diagram depicted in FIG. 9, the high-frequency transmitting/receiving apparatus is composed of: a high-frequency oscillator 11 for generating a high-frequency signal; a branching device 12 connected to the high-frequency oscillator 11, for branching the high-frequency signal so that the branched high-frequency signal components may be outputted to one output end 12b and the other output end 12c thereof, respectively; a modulator 13 connected to the one output end 12b of the branching device 12, for modulating the high-frequency signal component branched at the one output end 12b so as to output a high-frequency signal intended for transmission; an isolator 18 having its one end 18a connected to an output end 13b of the modulator 13, for passing the high-frequency signal intended for transmission from one end 18a to the other end 18b thereof; a transmitting antenna 19 connected to the isolator 18; a receiving antenna 20 connected relatively to the other output end 12c of the branching device 12; and a mixer 16, which is any one of the mixers accomplished by way of the embodiments of the invention. The mixer 16 includes two input ends 16a and 16b that are each connected between the other output end 12c of the branching device 12 and the receiving antenna 20, for mixing the high-frequency signal component branched at the other output end 12c and a high-frequency signal received by the receiving antenna 20 so as to generate an intermediate-frequency signal.

Moreover, the high-frequency transmitting/receiving apparatus 120 of the invention shown in FIG. 9 employs a nonradiative dielectric line as a high-frequency transmission line for providing connection among the constituent elements. The nonradiative dielectric line in use has basically the same structure as that shown in the partial cutaway perspective view depicted in FIG. 17.

More specifically, as shown in the plan view depicted in FIG. 10, the high-frequency transmitting/receiving apparatus 120 of the invention shown in FIG. 9 is composed of a pair of parallel plate conductors 31 disposed at an interval equal to or less than one half of the wavelength of a high-frequency signal (one of the parallel plate conductors is not illustrated). Arranged between the two parallel plate conductors 31 are: a first dielectric strip line 32; the high-frequency oscillator 11 connected to one end of the first dielectric strip line 32, for frequency-modulating a high-frequency signal outputted from a high-frequency diode and putting out the frequency-modulated high-frequency signal that has propagated through the first dielectric strip line 32; the modulator 13 having an input end 13a and an output end 13b that is connected to the other end of the first dielectric strip line 32, for allowing the high-frequency signal to reflect toward the input end 13a or pass toward the output end 13b in response to a pulse signal; a second dielectric strip line 33 which has its one end connected to the output end 13b of the modulator 13; the circulator 14, formed of a ferrite plate 34 disposed in parallel with the parallel plate conductors 31, having a first terminal 34a, a second terminal 34b, and a third terminal 34c that are arranged about the periphery of the ferrite plate 34 and respectively act as high-frequency signal input and output ends, of which the first terminal 34a is connected to the other end of the second dielectric strip line 33, wherein a high-frequency signal inputted from one of the terminals is outputted from the other adjoining terminal in turn, in order from the first through third terminals; a third dielectric strip line 35 and a fourth dielectric strip line 36, arranged radially about the periphery of the ferrite plate 34 constituting the circulator 14, that have their one ends connected to the second terminal 34b and the third terminal 34c, respectively; the transmitting antenna 19 connected to the other end of the third dielectric strip line 35; a fifth dielectric strip line 37 which has its mid-portion placed in the proximity of or coupled with the mid-portion of the first dielectric strip line 32, for branching and transmitting part of a high-frequency signal propagating through the first dielectric strip line 32; a nonreflective terminator 38a connected to the other end of the fourth dielectric strip line 36; a nonreflective terminator 38b connected to one high-frequency oscillator ll-side end of the fifth dielectric strip line 37; a sixth dielectric strip line 39 which has its one and connected to the receiving antenna 20; and the mixer 16, which is any one of the mixers accomplished by way of the embodiments of the invention. The mixer 16 is connected between the other end of the fifth dielectric strip line 37 and the other end of the sixth dielectric strip line 39, for mixing a high-frequency signal inputted from the fifth dielectric strip line 37 and a high-frequency signal inputted from the sixth dielectric strip line 39 after being received by the receiving antenna 20 so as to generate an intermediate-frequency signal. Note that the first and fifth dielectric strip lines 32 and 37 constitute the branching device 12 at their mutually adjacent or coupled portions. The isolator 18 comprises a circulator 14, the fourth dielectric strip line 36, and the nonreflective terminator 38a. Note that the first terminal 34a and the second terminal 34b in FIG. 10 correspond to the first terminal 18a and the second terminal 18b in FIG. 9, respectively.

The high-frequency transmitting/receiving apparatus 120 of the invention thus constructed is similar to the conventional high-frequency transmitting/receiving apparatus in terms of operation. However, in the high-frequency transmitting/receiving apparatus, by virtue of the mixer 16 of the invention, the mixing characteristics and the transmission characteristics of the mixer can be tuned appropriately in accordance with the property of the Schottky-barrier diode 45 acting as a high-frequency detection element, such as characteristics of noise generated by a resistance component of the Schottky-barrier diode 45, and the manner of mounting the Schottky-barrier diode 45. This makes it possible to realize a high-performance high-frequency transmitting/receiving apparatus that offers excellent reception sensitivity with stability.

Further, in the above constitution, it is preferable that an output end of the mixer 16 is provided with a switch 17 which performs opening/closing (switching) in accordance with an open/close controlling signal from the outside. When the switch 17 for performing opening/closing (switching) in accordance with the open/close controlling signal from the outside is provided on the output end of the mixer 16, that is the output portion 16c for putting the generated intermediate frequency signal, even if, for example, an insufficient isolation between the transmitting antenna 19 and the receiving antenna 20 causes a leakage of a part of the high-frequency signal intended for transmission into the receiving antenna 20, it is possible to operate the switch 17 so as to cut off such an intermediate frequency signal in order not to output the intermediate frequency signal to the leaked high-frequency signal and therefore, the high-frequency signal to be received can be made to be easily identified.

Next, the high-frequency transmitting/receiving apparatus 130 according to the third embodiment of the invention will be described with reference to FIG. 11. The high-frequency transmitting/receiving apparatus is composed of: a high-frequency oscillator 11 for generating a high-frequency signal; an RF selector switch 71 connected to the high-frequency oscillator 11, for allowing selection between a mode of outputting the high-frequency signal to the one output end 71b thereof as a high-frequency signal intended for transmission RFt and a mode of outputting the high-frequency signal to the other output end 71c thereof as a local signal L0; a second RF selector switch 72 provided as a signal separating device, having an input end 72b, an output end 72c, and an input/output end 72a, of which the input end 72b is connected to the one output end 71b of the RF selector switch 71, for allowing selection between a mode of connecting the input/output end 72a to the input end 72b and a mode of connecting the input/output end 72a to the output end 72c; a transmitting/receiving antenna 15 connected to the input/output end 72a of the second RF selector switch 72; and a mixer 16, which is any one of the mixers accomplished by way of the embodiments of the invention. The mixer 16 is connected between the other output end 71c of the RF selector switch 71 and the output end 72c of the second RF selector switch 72, for mixing the local signal L0 outputted to the other output end 71c and a high-frequency signal received by the transmitting/receiving antenna 15 so as to generate an intermediate-frequency signal.

In other words, the RF selector switch 71 has an input portion 171a and two output portions 171b, 171c, of which input portion 171a is connected to the high-frequency oscillator 11. The RF selector switch 71 selectively outputs the high-frequency signal given by the high-frequency oscillator 11 to one output portion 171b or the other output portion 171c. The second RF selector switch 72 provided as a signal separating device has the first terminal 72b, the second terminal 72a, and the third terminal 72c. By switching a connection mode among the first terminal 72b, the second terminal 72a, and the third terminal 72c, the high-frequency signal intended for transmission is given from the RF selector switch 71 to the first terminal 72b so that the high-frequency signal inputted from the first terminal 72b is outputted from the second terminal 72a, and the high-frequency signal inputted from the second terminal 72a is outputted from the third terminal 72c. The mixer 16 is connected to the other output portion 171c of the RF selector switch 71 and the third terminal 72c of the second RF selector switch 72.

Further, in the above constitution, it is preferable that an output end of the mixer 16 is provided with a switch 17 which performs opening/closing (switching) in accordance with an open/close controlling signal from the outside.

When the high-frequency signal intended for transmission is outputted from the transmitting/receiving antenna 15, a control signal is given from the outside to the selector switch 71 and the second selector switch 72 so that the high-frequency signal given to the input portion 171a is outputted from one output portion 171b in the selector switch 71, and the high-frequency signal given to the first terminal 72b is given to the second terminal 72a in the second selector switch 72. Moreover, when the high-frequency signal is received by the transmitting/receiving antenna 15, the control signal is given from the outside to the selector switch 71 and the second selector switch 72 so that the high-frequency signal given to the input portion 171a is outputted from the other output portion 171c in the selector switch 71, and the high-frequency signal given to the first terminal 72b is given to the third terminal 72c in the second selector switch.

Moreover, the high-frequency transmitting/receiving apparatus 140 according to the fourth embodiment of the invention will be described with reference to FIG. 12. The high-frequency transmitting/receiving apparatus is composed of: a high-frequency oscillator 11 for generating a high-frequency signal; an RF selector switch 71 connected to the high-frequency oscillator 11, for allowing selection between a mode of outputting the high-frequency signal to the one output end 71b thereof as a high-frequency signal intended for transmission RFt and a mode of outputting the high-frequency signal to the other output end 71c thereof as a local signal L0; a transmitting antenna 19 connected to the one output end 71b of the RF selector switch 71, that is the other output portion 171b; a receiving antenna 20 connected relatively to the other output end 71c of the RF selector switch 71; and a mixer 16, which is any one of the mixers accomplished by way of the embodiments of the invention. The mixer 16 is connected between the other output end 71c of the RF selector switch 71 and the receiving antenna 20, in other words, having one input end 16a connected to the other output portion 171c and the other input end 16b connected to the receiving antenna 20, for mixing the local signal L0 outputted to the other output end 71c and a high-frequency signal received by the receiving antenna 20 so as to generate an intermediate-frequency signal.

Further, in the above constitution, it is preferable that an output end of the mixer 16 is provided with a switch 17 which performs opening/closing (switching) in accordance with an open/close controlling signal from the outside.

When the high-frequency signal intended for transmission is outputted from the transmitting/receiving antenna 15, a control signal is given from the outside to the selector switch 71 so that the high-frequency signal given to the input portion 171a is outputted from one output portion 171b in the selector switch 71. Moreover, when the high-frequency signal is received by the transmitting/receiving antenna 15, the control signal is given from the outside to the selector switch 71 so that the high-frequency signal given to the input portion 171a is outputted from the other output portion 171c in the selector switch 71

Next, the high-frequency transmitting/receiving apparatus 150 according to the fifth embodiment of the invention will be described. As shown in the block circuit diagram depicted in FIG. 13, the high-frequency transmitting/receiving apparatus is composed of: a high-frequency oscillator 11 for generating a high-frequency signal; a rat-race hybrid coupler 73 connected to the high-frequency oscillator 11, for branching the high-frequency signal so that the branched high-frequency signal components may be outputted to one output end 73b and the other output end 73c thereof, respectively; a termination resistor 74 connected between the one output end 73b and the other output end 73c; a second rat-race hybrid coupler 75 having a first terminal 75b, a second terminal 75a, and a third terminal 75c, of which the first terminal 75b receives an output from the one output end 73b of the rat-race hybrid coupler 73, wherein a high-frequency signal inputted from one of the terminals is outputted from the other adjoining terminal in turn, in order from the first through third terminals; a termination resistor 76 connected between the first terminal 75b and the third terminal 75c; a transmitting/receiving antenna 15 connected to the second terminal 75a of the second rat-race hybrid coupler 75; and a mixer 16, which is any one of the mixers accomplished by way of the embodiments of the invention. The mixer 16 includes two input ends 16a and 16b that are each connected between the other output end 12c of the rat-race hybrid coupler 73 and the third terminal 75c of the second rat-race hybrid coupler 75, for mixing the high-frequency signal component branched at the other output end 73c and a high-frequency signal received by the transmitting/receiving antenna 15 so as to generate an intermediate-frequency signal.

Next, the high-frequency transmitting/receiving apparatus 160 according to the sixth embodiment of the invention will be described. As shown in the block circuit diagram depicted in FIG. 14, the high-frequency transmitting/receiving apparatus is composed of: a high-frequency oscillator 11 for generating a high-frequency signal; a rat-race hybrid coupler 73 connected to the high-frequency oscillator 11, for branching the high-frequency signal so that the branched high-frequency signal components may be outputted to one output end 73b and the other output end 73c thereof, respectively; a termination resistor 74 connected between the one output end 73b and the other output end 73c; a transmitting antenna 19 connected to the one output end 73b of the rat-race hybrid coupler 73; a receiving antenna 20 connected relatively to the other output end 73c of the rat-race hybrid coupler 73; and a mixer 16, which is anyone of the mixers accomplished by way of the embodiments of the invention. The mixer 16 includes two input ends 16a and 16b that are each connected between the other output end 12c of the rat-race hybrid coupler 73 and the receiving antenna 20, for mixing the high-frequency signal component branched at the other output end 73c and a high-frequency signal received by the receiving antenna 20 so as to generate an intermediate-frequency signal.

In each of the high-frequency transmitting/receiving apparatuses 130, 140, 150, 160 embodying the invention, the high-frequency transmission line for use should preferably be selected from among a nonradiative dielectric line, a dielectric waveguide line, a waveguide, a dielectric waveguide, a strip line, a micro-strip line, a coplanar line, and a slot line.

Moreover, both the RF selector switch 71 and the second RF selector switch 72 may be designed in analogy to the design of the modulator 13.

Preferably, the RF selector switch 71 is provided with a branching device for branching an inputted high-frequency signal so that the branched high-frequency signal components may be outputted to one output end and the other output end thereof, respectively, and first and second PIN diodes connected to one output end and the other output end of the branching device, respectively. At least one of the first and second PIN diodes is connected with a bias circuit for applying a bias voltage in a forward direction. In this case, at least one of the first and second PIN diodes exhibits a low impedance, and therefore, even if switching is made to the first and second PIN diodes, the impedance can constantly be kept low and stabilized, when viewed as from the high-frequency signal input side (the high-frequency oscillator 11 side). This makes it possible to suppress load variation in the high-frequency oscillator 11 without employing an isolator or the like device, and thereby stabilize the oscillation frequency of the high-frequency signal.

In any of the high-frequency transmitting/receiving apparatuses 110, 120, 130, 140 embodying the invention, by virtue of the mixer of the invention, the mixing characteristics and the transmission characteristics of the mixer can be tuned appropriately in accordance with the property of the high-frequency detection element and the manner of mounting the high-frequency detection element. This makes it possible to realize a high-performance high-frequency transmitting/receiving apparatus that offers excellent reception sensitivity with stability.

In the high-frequency transmitting/receiving apparatus embodying the invention, each of the first through sixth dielectric strip lines 22, 23, 25 to 27, 32, 33, 35 to 37, and 39 should preferably be made of a resin material such as tetrafluoroethylene or polystyrene, and a ceramic material such as cordierite (2MgO.2Al₂O₃.5SiO₂) ceramics having a low permittivity, alumina (Al₂O₃) ceramics, and glass ceramics. These materials exhibit low loss to high-frequency signals in a millimeter-wave band.

Moreover, although the first through sixth dielectric strip lines 22, 23, 25 to 27, 32, 33, 35 to 37, and 39 are each given a substantial rectangular cross-sectional profile basically in one virtual plane perpendicular to an extending direction, they may have their corners rounded off. That is, the dielectric strip line may have a cross-sectional profile of various shapes so long as high-frequency signals are transmitted properly.

As a material used for the ferrite plate 24, 34, it is preferable to use a zinc-nickel-iron composite oxide (ZnₐNi_{b}Fe_{c}Oₓ) that is particularly desirable to high-frequency signals.

Moreover, although the ferrite plate 24, 34 is disc-shaped as is normally the case, it may have the shape of a regular polygon, as viewed plane-wise, that is as viewed from one side of a thickness direction. In this case, given the number of dielectric strip lines connected thereto of n (n represents an integer of 3 or more), then the planar configuration of the ferrite plate should preferably be m-sided regular polygon (m represents an integer of 3 or more, wherein m>n).

As a material used for the parallel plate conductor 21, 31 and the non-illustrated pair fellow thereto, it is preferable to use a conductor plate made of Cu, Al, Fe, Ag, Au, Pt, SUS (stainless steel), brass (Cu—Zn alloy), or the like material, from the viewpoint of high electric conductivity and excellent processability. It is also possible to use an insulation plate made of ceramics or resin having layers of such conductor materials as mentioned above formed on the surface thereof.

The nonreflective terminator 28, 38a, and 38b are connected with the fifth dielectric strip line 27, the fourth dielectric strip line 36, and the fifth dielectric strip line 37, respectively. Such a nonreflective terminator is fabricated by attaching a film-like resistive element or wave absorber to the upper and lower ends of each side face (the face disposed in face-to-face relationship with neither the inner face of the parallel plate conductor 21, 31 nor the inner face of the non-illustrated pair fellow thereto) at the end of its corresponding dielectric strip line. At this time, a nickel-chromium alloy or carbon is suitable for use as the resistive element, while permalloy or sendust is suitable for use as the wave absorber. By using such a material, it is possible to attenuate millimeter-wave signals with high efficiency. Note that the resistive element or wave absorber may be formed of any other given material so long as it enables attenuation of millimeter-wave signals.

The substrate 40, 44 is fabricated by forming, on one main surface of a platy base substrate made of tetrafluoroethylene, polystyrene, glass ceramics, glass epoxy resin, epoxy resin, and thermoplastic resin such as so-called liquid crystal polymer, the choke-type bias supply line 41, 46 formed of a strip conductor or the like made of aluminum (Al), gold (Au), copper (Cu), and the like metal.

It should be noted that a distinctive feature of the high-frequency transmitting/receiving apparatus 110, 120, 130, 140 of the invention is to include the mixer of the invention. In this construction, the high-frequency transmission line for providing connection among the circuit elements is not limited to the nonradiative dielectric line, but may be of another configuration such as a waveguide, a dielectric waveguide, a strip line, a micro-strip line, a coplanar line, a slot line, a coaxial line, or a modified form of a high-frequency transmission line of such a kind. The form selection is made in consideration of the frequency band for use and purposes. Moreover, the usable frequency band corresponding to high-frequency signals is not limited to a millimeter-wave band, but may be of a micro-wave band, or even below.

Instead of the circulator 14, it is possible to use a duplexer, a switch, a hybrid circuit, or the like. Moreover, for constituting the high-frequency oscillator, the modulator, and the mixer, it is possible to use a bipolar transistor, a field-effect transistor (FET), or an integrated circuit using such elements (CMOS, MMIC, etc) instead of a diode.

Next, a description will be given below as to a radar apparatus embodying the invention, a vehicle equipped with the radar apparatus, and a small boat equipped with the radar apparatus.

The radar apparatus according to one embodiment of the invention includes one of the high-frequency transmitting/receiving apparatuses of the invention and a distance information detector for detecting data on a distance to an object to be detected by processing the intermediate-frequency signal outputted from the high-frequency transmitting/receiving apparatus.

According to the radar apparatus of the invention, the high-frequency transmitting/receiving apparatus of the invention included therein enjoys higher performance, that is, offers excellent reception sensitivity with stability and allows transmission of high-frequency signals with high transmission power ON/OFF ratio. Thus, not only it is possible to detect an object to be detected swiftly without fail, but it is also possible to detect both nearby and far-off target objects successfully without fail.

The radar-bearing vehicle of the invention is equipped with the radar apparatus of the invention described just above. The radar apparatus is used to detect an object to be detected.

By virtue of its structure, the radar-bearing vehicle of the invention is, like a conventional radar-bearing vehicle, capable of controlling its behavior on the basis of the distance information detected by the radar apparatus and warning a driver of, for example, presence of an obstruction on the road or approach of other vehicles by sound, light, or vibration. In addition to that, in the radar-bearing vehicle of the invention, the radar apparatus acts to detect swiftly an object to be detected, for instance, an obstruction on the road or other vehicles without fail. This makes it possible to exercise proper control of the vehicle and to give a driver a warning appropriately without causing abrupt actions in the vehicle.

Further, even if the vehicle vibrates, the above described resistance of the trimmable chip resistor 3 is not caused to vary, and moreover even if the radar apparatus is disposed outside the vehicle, the resistance is hard to vary against temperature and moisture variation and therefore, the predetermined mixing characteristics and transmission characteristics can be favorably maintained so that the stable radar apparatus can realize a stable operation for detection.

Specifically, the radar-bearing vehicle of the invention finds a wider range of applications including a bicycle, a motor-assisted bicycle, a ride designed for use in an amusement park, and a cart used in a golf course, let alone a steam train, an electric train, an automobile, and a truck for transportation.

The radar-bearing small boat of the invention is equipped with the radar apparatus of the invention described above. The radar apparatus is used to detect an object to be detected.

By virtue of its structure, the radar-bearing small boat of the invention is, like a conventional radar-bearing vehicle, capable of controlling its behavior on the basis of the distance information detected by the radar apparatus and warning an operator of, for example, presence of an obstruction such as a reef or approach of other vessels or crafts by sound, light, or vibration. In addition to that, in the radar-bearing small boat of the invention, the radar apparatus acts to detect swiftly an object to be detected, for instance, an obstruction such as a reef or other vessels or crafts without fail. This makes it possible to exercise proper control of the small boat and to give an operator a warning appropriately without causing abrupt actions in the small boat.

Further, even if the boat vibrates, the above described resistance of the trimmable chip resistor 3 is not caused to vary, and more over even if the radar apparatus is disposed outside the boat, the resistance is hard to vary against temperature and moisture variation and therefore, the predetermined mixing characteristics, transmission characteristics and the like can be favorably maintained so that the stable radar apparatus can realize a stable operation for detection.

The radar-bearing small boat of the invention may be applied to boats of various kinds that can be operated by both licensed and unlicensed operators, specifically, a foyboat whose total tonnage is less than 20 tons; a dinghy; a wet bike; an outboat motor-mounted small bass fishing boat; an outboat motor-mounted inflatable boat (rubber boat); a fishing vessel; a leisure fishing boat; a working boat; an old-fashioned houseboat; a towing boat; a sport boat; a fishing boat; a yacht; an oceangoing yacht; a cruiser; and a pleasure boat whose total tonnage is 20 tons or above.

As described heretofore, according to the invention, there are provided: a mixer in which a bias supply circuit of a high-frequency detection element for constituting the mixer is provided with a pre-set variable resistor thereby to keep mixing characteristics and transmission characteristics of the mixer tuned satisfactorily; a high-frequency transmitting/receiving apparatus having the mixer that is remarkable for constructional simplicity and performance, and is capable of offering excellent reception performance, with high transmission power ON/OFF ratio, by preventing part of a high-frequency signal intended for transmission from being transmitted as an unwanted signal when a modulator is kept in an OFF state; a radar apparatus having the high-frequency transmitting/receiving apparatus of outstanding performance; a vehicle equipped with the radar apparatus; and a small boat equipped with the radar apparatus.

### IMPLEMENTATION EXAMPLE

As an actual implementation example, the high-frequency transmitting/receiving apparatus 110 of the invention as shown in FIGS. 6 and 7 was constructed as follows. As a pair of parallel plate conductors 21 (one of them is not illustrated in the figures), two pieces of 6 mm-thick Al (aluminum) plates were arranged at an interval of 1.8 mm so as to have surfaces thereof in a thickness direction confronted each other. Between the Al plates were interposed the first to fifth dielectric strip lines 22, 23, and 25 to 27 made of cordierite ceramics having a relative dielectric constant of 4.8. Each of the dielectric strip lines has a sectional profile of 1.8 mm in height and 0.8 mm in width in one virtual plane perpendicular to an extending direction of the lines. As the circulator 14, two pieces of ferrite plates 24 each having a diameter of 2 mm and a thickness of 0.23 mm were prepared for use. One of them was brought into intimate contact with one parallel plate conductor 21 (the upper parallel plate conductor), whereas the other was brought into intimate contact with the other parallel plate conductor 21 (the lower parallel plate conductor). These ferrite plates 24 were arranged concentrically face to face with each other. Arranged radially about the periphery of the ferrite plate 24 are the second dielectric strip line 23, the third dielectric strip line 25, and the fourth dielectric strip line 26. Moreover, the branching device 12 was formed by proximately placing a mid-portion of the first dielectric strip line 22 and a mid-portion of the fifth dielectric strip line 27, with a spacing of 2.1 mm secured between the closest proximate portions thereof. Connected to one high-frequency oscillator 11-side end of the fifth dielectric strip line 27 is the nonreflective terminator 28. Further, the modulator 13 was formed by placing, between the first dielectric strip line 22 and the second dielectric strip line 23, a millimeter-wave modulation switch composed of the substrate 40 made of a 0.2 mm-thick, low-permittivity thermoplastic resin-made organic resin substrate (relative dielectric constant εr=3.0). On one main surface of the high-frequency wave modulation switch (the surface thereof opposite from the surface facing the first dielectric strip line 22) was formed the choke-type bias supply line 41 made of copper having broad strip lines and narrow strip lines, which are shown in FIG. 8, arranged in an alternating manner. The length of the broad strip line is given by the expression: λ₁/4=0.7 mm (λ₁ is equal to 2.8 mm relative to the wavelength of approximately 4 mm of a high-frequency signal at a frequency of 76.3 GHz; that is, it is made shorter in wavelength on the dielectric substrate), and the length of the narrow strip line is given by the expression: λ₁/4=0.7 mm. The widths of the broad strip line and the narrow strip line were set at 1.5 mm and 0.2 mm, respectively. Next, as the high-frequency oscillator 11, a pill-type voltage-controlled oscillator (VCO) employing a Gunn diode was prepared for use. The VCO was connected to the other end of a waveguide, one end of which is connectedly inserted into a through hole drilled in part of the parallel plate conductor 21 where the electric field of a standing wave corresponding to a high-frequency signal propagating through the first dielectric strip line 22 is strong. Then, the transmitting/receiving antenna 15 was connected to one end of the third dielectric strip line 25 opposite from the other end connected with the ferrite plate 24. Note that the ferrite plate 24 is made of a material that exhibits a relative dielectric constant of 13.5 and saturation magnetization of 3,300 G (Gauss) (the magnetic flux density Bm measured in accordance with TIS C2561 using a certain DC-magnetometry technique)

Lastly, as the mixer 16, a balance-type mixer was formed as follows. As shown in FIG. 2, a mid-portion of the fourth dielectric strip line 26 and a mid-portion of the fifth dielectric strip line 27 were arranged in proximity to each other, with a spacing of 1.1 mm secured between the closest proximate portions thereof. Then, a high-frequency detection portion was arranged respectively at one end of the fourth dielectric strip line 26 opposite from the other end connected with the ferrite plate 24 and one end of the fifth dielectric strip line 27 opposite from the other end connected with the branching device 12. The high-frequency detection portion is composed of the substrate 44 made of a 0.2 mm-thick, low-permittivity thermoplastic resin-made organic resin substrate (relative dielectric constant εr=3.0). As shown in FIG. 3, on one main surface of the high-frequency detection portion (the surface thereof opposite from the surface facing the fourth, fifth dielectric strip line 26, 27) was formed the choke-type bias supply line 46 made of copper having broad strip lines 46a and narrow strip lines 46b arranged in an alternating manner. The length of the broad strip line 46a is given by the expression: λ₁/4=0.7 mm (λ₁ is equal to 2.8 mm relative to the wavelength of approximately 4 mm of a high-frequency signal at a frequency of 76.3 GHz; that is, it is made shorter in wavelength on the dielectric substrate), and the length of the narrow strip line 46b is given by the expression: λ₁/4=0.7 mm. The widths of the broad strip line 46a and the narrow strip line 46b were set at 1.5 mm and 0.2 mm, respectively. Moreover, as shown in the circuit diagram depicted in FIG. 1, connected to the end of the choke-type bias supply line 46 were the direct current voltage source 5 and the trimmable chip resistor 3 as shown in FIG. 5A. Note that the line lengths of the first and second dielectric strip lines 22 and 23 were determined in such a way that the difference in phase 6 between the high-frequency signals Wa₂ and Wb₂ is substantially equal to π at 76.3 GHz: the center frequency of a high-frequency signal intended for transmission.

In the high-frequency transmitting/receiving apparatus thus constructed, at the outset, the resistance of the trimmable chip resistor 3 was adjusted properly. Then, a bias current passing through the Schottky-barrier diode 45 (2) of the mixer 16 was caused to vary within a range from 0 to 5 mA. In this state, the intensity Pa₂ and Pb₂ of the high-frequency signals Wa₂ and Wb₂ were measured in the following manner with use of a vector network analyzer designed for use in a millimeter-wave band. Firstly, the VCO was detached from the end of the waveguide so that a first test terminal (test port 1) of the vector network analyzer can be connected to the end. Subsequently, the transmitting/receiving antenna 19 was detached from the end of the third dielectric strip line 25 so that a second test terminal (test port 2) can be connected to the end. Then, the transmission characteristics S₂₁ between the first and second test terminals was measured. At this time, in the case of conducting measurement on the high-frequency signal Wa₂ transmitted through the modulator 13 placed in an OFF state, an electromagnetic wave-blocking metal plate is inserted between the first dielectric strip line 22 and the fifth dielectric strip line 27 to cut off the high-frequency signal Wb₂. On the other hand, in the case of conducting measurement on the high-frequency signal Wb₂ reflected from the output end 13b of the modulator 13, instead of the high-frequency modulation switch, an electromagnetic wave-blocking metal plate is inserted between the first dielectric strip line 22 and the second dielectric strip line 23 to cut off the high-frequency signal Wa₂. That is, measurement of the transmission characteristics S₂₁ was conducted for each of the high-frequency signals Wa₂ and Wb₂ on an individual basis. Here, under the condition that the intensity of a high-frequency signal outputted from the first test terminal is 0 dBm, the intensity Pa₂ and Pb₂ were derived on the basis of the measured values of the transmission characteristics S₂₁. FIG. 15 is a chart showing an example of the measurement results.

FIG. 15 is a chart showing the intensity Pa₂ and Pb₂ of the high-frequency signals Wa₂ and Wb₂ as observed in the implementation example of the high-frequency transmitting/receiving apparatus 110 according to the invention. In FIG. 15, a bias current present in the mixer is taken along the horizontal axis (unit: mA) and the intensity of the high-frequency signal is taken along the vertical axis (unit: dBm). Moreover, the intensity Pa₂ of the high-frequency signal Wa₂ at a frequency of 76.3 GHz is plotted by solidly shaded circles, whereas the intensity Pb₂ of the high-frequency signal Wb₂ at a frequency of 76.3 GHz is plotted by solidly shaded tetragons.

As will be understood from FIG. 15, the intensity Pb₂ of the high-frequency signal Wb₂ varies depending upon the value of the bias current present in the mixer. It has thus been confirmed that, by changing the resistance of the trimmable chip resistor 3 properly, it is possible to cause the bias current passing through the Schottky-barrier diode 45 (2) to vary, and thereby the impedance at the output ends 26b and 27b of the fourth and fifth dielectric strip lines 26 and 27 can be varied, in consequence whereof there results a change in the transmission coefficient between the two input ends 16a and 16b of the mixer 16. For example, as shown in this example, by adjusting the resistance of the trimmable chip resistor 3 in such a way that the bias current present in the mixer stands at 2 mA, it is possible to ensure that the intensity Pa₂ of the high-frequency signal Wa₂ and the intensity Pb₂ of the high-frequency signal Wb₂ are substantially equal.

Next, the high-frequency transmitting/receiving apparatus 110 was operated under actual conditions to measure ON/OFF ratio characteristics at a bias current of 0 to 2.5 mA in the mixer. At the outset, the VCO was driven to oscillate stably, with its oscillation power kept invariant. Subsequently, the transmitting/receiving antenna 15 was detached from the end of the third dielectric strip line 25 so that a test terminal of a spectrum analyzer designed for use in a millimeter-wave band can be connected to the end. In this state, for each of the case where the modulator 13 is placed in an ON state and the case where it is placed in an OFF state, the intensity of a high-frequency signal outputted from the end was measured while performing frequency scanning step by step. Thereby, the ratio between two measurement values, namely, ON/OFF ratio, was obtained. The measurement results are shown in a chart depicted in FIG. 16. In the chart, the high-frequency signal intensity obtained as transmission power when the modulator 13 is placed in an ON state is defined by W_on (unit: watt), whereas the high-frequency signal intensity obtained as transmission power when the modulator 13 is placed in an OFF state is defined by W_off (unit: watt) Here, the frequency of the high-frequency signal was made To vary in a range between about 75.8 GHz and about 76.8 GHz.

FIG. 16 is a chart showing transmission power ON/OFF ratio characteristics as observed in Implementation example of the high-frequency transmitting/receiving apparatus according to the invention. In FIG. 16, a frequency is taken along the horizontal axis (unit: GHz) and the transmission power ON/OFF ratio is taken along the vertical axis (unit: dB), which is represented by a reciprocal number (−10 log (W_on/W_off)). Moreover, the representative actual measurement values of the transmission power ON/OFF ratio characteristics that correspond to 0.0, 0.5, 1.0, 1.5, 2.0, and 2.5 mA (bias current values of the mixer), respectively, are plotted by open tetragons, open circles, open triangles, solidly shaded tetragons, solidly shaded circles, and solidly shaded triangles, respectively. Note that, in FIG. 16, the ON/OFF ratio is represented by a reciprocal number. Therefore, the smaller the plotted actual measurement values, the higher the ON/OFF ratio; that is, the better the transmission power ON/OFF ratio characteristics.

As will be understood from the measurement results shown in FIG. 16, when the bias current present in the mixer is 2.0 mA at which the intensity Pa₂ of the high-frequency signal Wa₂ and the intensity Pb₂ of the high-frequency signal Wb₂ are substantially equal, the highest ON/OFF ratio is obtained at 76.3 GHz: the center frequency of a high-frequency signal intended for transmission. It has thus been found desirable to make a tuning on the resistance of the trimmable chip resistor 3 in such a way that the relationship between the intensity Pa₂ of the high-frequency signal Wa₂ and the intensity Pb₂ of the high-frequency signal Wb₂ is given by: Pa₂=Pb₂. By doing so, in the region between the output end 13b of the modulator 13 and the circulator 14, the high-frequency signals Wa₂ and Wb₂ are synthesized in phase opposition and cancel out each other thereby to cause attenuation effectively. This makes it possible to obtain high transmission power ON/OFF ratio by preventing part of a high-frequency signal intended for transmission from being transmitted as an unwanted signal when the modulator 13 is kept in an OFF state.

When adjusting the mixing characteristics and transmission characteristics of the mixer, the resistance of the trimmable chip resistor 3 is made to be step-by-step larger from the lowest resistance of the trimmable chip resistor 3. By increasing the resistance of the trimmable chip resistor 3, it is possible to decrease the bias current passing through the Schottky-barrier diode 2. The resistance of the trimmable chip resistor 3 is increased until the current passing through the Schottky-barrier diode 2 reaches around 2.0 mA, thereby the transmission power ON/OFF ratio can be higher. Since the trimmable chip resistor 3 is an irreversible resistor, the adjustment of the mixing characteristics and transmission characteristics of the mixer is thus conducted by varying the bias current passing through the Schottky-barrier diode 2 in one direction, here by decreasing it.

Through an evaluation test similar to that conducted on the high-frequency transmitting/receiving apparatus of the invention thus far described, it has been confirmed that the high-frequency transmitting/receiving apparatus 120 of the invention also succeeds in providing high transmission power ON/OFF ratio.

Lastly, a radar apparatus equipped with the high-frequency transmitting/receiving apparatus of the invention was constructed. The radar apparatus was subjected to a radar detection test to evaluate its capability of detecting an approaching target object. It has been confirmed from the test result that the radar apparatus, in which tuning was made in the above-stated manner so as for the mixer to act properly, is capable of producing distance information swiftly without fail.

As described heretofore, according to the invention, there are provided: a mixer in which a bias supply circuit of a high-frequency detection element for constituting the mixer is provided with a pre-set variable resistor thereby to keep characteristics such as mixing characteristics and transmission characteristics of the mixer tuned satisfactorily; a high-frequency transmitting/receiving apparatus having the mixer that is remarkable for constructional simplicity and performance, and is capable of offering excellent reception performance, with high transmission power ON/OFF ratio, by preventing part of a high-frequency signal intended for transmission from being transmitted as an unwanted signal when a modulator is kept in an OFF state; and a radar apparatus capable of performing radar detection swiftly without fail.

It is to be understood that the application of the invention is not limited to the specific embodiments and examples described heretofore, and that many modifications and variations of the invention are possible within the spirit and scope of the invention. For example, the pre-set variable resistor may be constituted by a fixed resistor network formed by connecting together a plurality of fixed resistors, the contacts of which are relay switchable. In this case, the resistance of the fixed resistor network can be determined dynamically. For example, in response to changes in environmental conditions, a bias current present in the mixer 16 can be changed dynamically so as for the mixer 16 to act appropriately, or the bias current present in the mixer 16 can be changed in synchronization with the operation of the modulator 13.

The invention may be embodied in other specific forms without departing from the spirit or essential characteristics thereof. The present embodiments are therefore to be considered in all respects as illustrative and not restrictive, the scope of the invention being indicated by the appended claims rather than by the foregoing description and all changes which come within the meaning and the range of equivalency of the claims are therefore intended to be embraced therein.

What is claimed is:

1. A mixer comprising:
a coupler having two input ends and one or two output ends;
a high-frequency detection element disposed at the output end of the coupler; and
a bias supply circuit connected to the high-frequency detection element, for supplying a bias current to the high-frequency detection element;
wherein the high-frequency detection element is provided with a pre-set variable resistor for controlling the bias current which passes through the high-frequency detection element.

2. The mixer of claim 1, wherein a trimmable chip resistor is employed as the pre-set variable resistor of the mixer.

3. A high-frequency transmitting/receiving apparatus comprising:
a high-frequency oscillator for generating a high-frequency signal;
a branching device having two output portions, connected to the high-frequency oscillator, for branching the high-frequency signal given by the high-frequency oscillator and outputting the branched high-frequency signal components from one and the other of the two output portions, respectively;
a modulator connected to the one output portion of the branching device, for modulating the branched high-frequency signal component and outputting a high-frequency signal intended for transmission;
a signal separating device having a first terminal, a second terminal, and a third terminal, for receiving at the first terminal the high-frequency signal intended for transmission from the modulator, for outputting from the second terminal the high-frequency signal intended for transmission inputted from the first terminal, and for outputting from the third terminal a high-frequency signal inputted from the second terminal;
a transmitting/receiving antenna connected to the second terminal; and
the mixer of claim 1 having, among the two input ends, one input end connected to the other output portion, and the other input end connected to the third terminal, for mixing the branched high-frequency signal component outputted from the other output portion and a high-frequency signal received by the transmitting/receiving antenna and generating an intermediate-frequency signal.

4. The high-frequency transmitting/receiving apparatus of claim 3, wherein, in the high-frequency transmitting/receiving apparatus, a transmission coefficient between the two input ends of the mixer is determined in such a way that the following expression holds: Pa₂=Pb₂, under the conditions that a high-frequency signal passing through the modulator placed in an OFF state is defined as Wa₂; a high-frequency signal that has been transmitted from the other output portion of the branching device to the output portion of the modulator by way of the mixer and the signal separating device, and then reflected from the output end of the output portion of the modulator is defined as Wb₂; an intensity of the high-frequency signal Wa₂ is represented by Pa₂; and an intensity of the high-frequency signal Wb₂ is represented by Pb₂.

5. The high-frequency transmitting/receiving apparatus of claim 4, wherein a line length between one output end of the output portion of the branching device and the modulator, or a line length between the other output end of the output portion of the branching device and the modulator, with the mixer and the signal separating device lying therebetween, is determined in such a way that the following expression holds: δ=(2N+1)·π (N represents an integer), where δ represents the difference in phase between the high-frequency signals Wa₂ and Wb₂ at a center frequency.

6. A high-frequency transmitting/receiving apparatus comprising:
a high-frequency oscillator for generating a high-frequency signal;
a branching device connected to the high-frequency oscillator, for branching the high-frequency signal given by the high-frequency oscillator so that the branched high-frequency signal components may be outputted from one output portion and the other output portion thereof, respectively;
a modulator connected to the one output portion of the branching device, for modulating the high-frequency signal component branched at the one output portion and outputting a high-frequency signal intended for transmission;
an isolator having an input terminal and an output terminal, for outputting the high-frequency signal intended for transmission from the output terminal thereof when the high-frequency signal intended for transmission is given from the modulator to the input terminal thereof;
a transmitting antenna connected to the output terminal;
a receiving antenna; and
the mixer of claim 1 having, among the two input ends, one input end connected to the other output portion of the branching device and the other input end connected to the receiving antenna, for mixing the branched high-frequency signal component outputted from the other output portion and a high-frequency signal received by the receiving antenna and generating an intermediate-frequency signal.

7. A high-frequency transmitting/receiving apparatus comprising:
a high-frequency oscillator for generating a high-frequency signal;
a switching device having two output portions, connected to the high-frequency oscillator, for selectively outputting the high-frequency signal given by the high-frequency oscillator from one or both of the output portions thereof;
a signal separating device having a first terminal, a second terminal, and a third terminal, for receiving at the first terminal a high-frequency signal intended for transmission from the one output portion of the switching device, for outputting from the second terminal the high-frequency signal intended for transmission inputted from the first terminal, and for outputting from the third terminal a high-frequency signal inputted from the second terminal;
a transmitting/receiving antenna connected to the second terminal; and
the mixer of claim 1 having, among the two input ends, one input end connected to the other output portion and the other input end connected to the third terminal, for mixing the high-frequency signal outputted from the other output portion and a high-frequency signal received by the transmitting/receiving antenna so as to generate an intermediate-frequency signal.

8. A high-frequency transmitting/receiving apparatus comprising:
a high-frequency oscillator for generating a high-frequency signal;
a switching device having two output portions, connected to the high-frequency oscillator, for selectively outputting the high-frequency signal given by the high-frequency oscillator from one or both of the output portions thereof;
a transmitting antenna connected to the one output portion of the switching device;
a receiving antenna; and
the mixer of claim 1 having, among the two input ends, one input end connected to the other output portion of the switching device and the other input end connected to the receiving antenna, for mixing the high-frequency signal outputted from the other output portion of the switching device and a high-frequency signal received by the receiving antenna so as to generate an intermediate-frequency signal.

9. A high-frequency transmitting/receiving apparatus comprising:
a high-frequency oscillator for generating a high-frequency signal;
a branching device having two output portions, connected to the high-frequency oscillator, for branching the high-frequency signal given by the high-frequency oscillator and outputting the branched high-frequency signal components from one and the other of the two output portions, respectively;
a signal separating device having a first terminal, a second terminal, and a third terminal, for receiving at the first terminal the high-frequency signal intended for transmission from the one output portion of the branching device, for outputting from the second terminal the high-frequency signal intended for transmission inputted from the first terminal, and for outputting from the third terminal the high-frequency signal inputted from the second terminal;
a transmitting/receiving antenna connected to the second terminal; and
the mixer of claim 1 having, among the two input ends, one input end connected to the other output portion, and the other input end connected to the third terminal, for mixing the branched high-frequency signal component outputted from the other output portion and a high-frequency signal received by the transmitting/receiving antenna and generating an intermediate-frequency signal.

10. A high-frequency transmitting/receiving apparatus comprising:
a high-frequency oscillator for generating a high-frequency signal;
a branching device connected to the high-frequency oscillator, for branching the high-frequency signal given by the high-frequency oscillator so that the branched high-frequency signal components may be outputted from one output portion and the other output portion thereof, respectively;
a transmitting antenna connected to the one output portion;
a receiving antenna; and
the mixer of claim 1 having, among the two input ends, one input end connected to the other output portion of the branching device and the other input end connected to the receiving antenna, for mixing the branched high-frequency signal component outputted from the other output portion and a high-frequency signal received by the receiving antenna and generating an intermediate-frequency signal.

11. A radar apparatus comprising:
the high-frequency transmitting/receiving apparatus of claim 3; and
a distance information detector for detecting data on a distance to an object to be detected by processing the intermediate-frequency signal outputted from the high-frequency transmitting/receiving apparatus.

12. A radar apparatus comprising:
the high-frequency transmitting/receiving apparatus of claim 6; and
a distance information detector for detecting data on a distance to an object to be detected by processing the intermediate-frequency signal outputted from the high-frequency transmitting/receiving apparatus.

13. A radar apparatus comprising:
the high-frequency transmitting/receiving apparatus of claim 7; and
a distance information detector for detecting data on a distance to an object to be detected by processing the intermediate-frequency signal outputted from the high-frequency transmitting/receiving apparatus.

14. A radar apparatus comprising:
the high-frequency transmitting/receiving apparatus of claim 8; and
a distance information detector for detecting data on a distance to an object to be detected by processing the intermediate-frequency signal outputted from the high-frequency transmitting/receiving apparatus.

15. A radar apparatus comprising:
the high-frequency transmitting/receiving apparatus of claim 9; and
a distance information detector for detecting data on a distance to an object to be detected by processing the intermediate-frequency signal outputted from the high-frequency transmitting/receiving apparatus.

16. A radar apparatus comprising:
the high-frequency transmitting/receiving apparatus of claim 10; and
a distance information detector for detecting data on a distance to an object to be detected by processing the intermediate-frequency signal outputted from the high-frequency transmitting/receiving apparatus.

17. A radar-bearing vehicle comprising the radar apparatus of claim 13, which is used to detect an object to be detected.

18. A radar-bearing vehicle comprising the radar apparatus of claim 14, which is used to detect an object to be detected.

19. A radar-bearing vehicle comprising the radar apparatus of claim 15, which is used to detect an object to be detected.

20. A radar-bearing vehicle comprising the radar apparatus of claim 16, which is used to detect an object to be detected.
